(19) United States
(12) Patent Application Publication
(10) Pub. No.: US 2026/0236675 A1
(43) Pub. Date: Aug. 13, 2026

(54) FACILITATING INTEROPERABILITY OF PHYSICAL AND ELECTRONIC DOCUMENTS

(71) Applicant: FACTIFY TECHNOLOGIES INC., Dover, DE (US)

(72) Inventors: Matan Gavish, Givat Ada (IL); Gil Asher, Binyamina (IL)

(21) Appl. No.: 19/638,732

(22) Filed: Apr. 3, 2026

Related U.S. Application Data
(63) Continuation of application No. PCT/US2025/033822, filed on Jun. 16, 2025.
(60) Provisional application No. 63/661,534, filed on Jun. 18, 2024.
(60) Provisional application No. 63/668,068, filed on Jul. 5, 2024.
(60) Provisional application No. 63/674,793, filed on Jul. 23, 2024.
(60) Provisional application No. 63/680,061, filed on Aug. 6, 2024.
(60) Provisional application No. 63/685,234, filed on Aug. 20, 2024.
(60) Provisional application No. 63/693,173, filed on Sep. 10, 2024.
(60) Provisional application No. 63/707,992, filed on Oct. 16, 2024.
(60) Provisional application No. 63/713,200, filed on Oct. 29, 2024.
(60) Provisional application No. 63/714,009, filed on Oct. 30, 2024.
(60) Provisional application No. 63/723,471, filed on Nov. 21, 2024.
(60) Provisional application No. 63/736,568, filed on Dec. 19, 2024.
(60) Provisional application No. 63/738,639, filed on Dec. 24, 2024.
(60) Provisional application No. 63/774,949, filed on Mar. 20, 2025.
(60) Provisional application No. 63/794,007, filed on Apr. 24, 2025.
(60) Provisional application No. 63/794,564, filed on Apr. 25, 2025.
(60) Provisional application No. 63/800,869, filed on May 6, 2025.
(60) Provisional application No. 63/822,629, filed on Jun. 12, 2025.
(60) Provisional application No. 63/925,068, filed on Nov. 25, 2025.
(60) Provisional application No. 63/943,892, filed on Dec. 18, 2025.
(60) Provisional application No. 63/944,143, filed on Dec. 18, 2025.
(60) Provisional application No. 63/962,034, filed on Jan. 16, 2026.
(60) Provisional application No. 64/002,016, filed on Mar. 10, 2026.
(60) Provisional application No. 64/010,751, filed on Mar. 19, 2026.

(51) Int. Cl. G06F 40/197; G06F 16/93; G06F 21/62

(52) U.S. Cl. CPC G06F 40/197; G06F 16/93; G06F 21/6218

(57) ABSTRACT

The aspects described herein pertain at least to a method implemented by a computer for facilitating control of an electronic document provisioned as digital infrastructure based on user interaction with a physical document. The method comprises, at least in part, receiving, by an application executing on the computer, a request to convert a physical document to an electronic document provisioned as digital infrastructure, and converting responsive to the request, by the application executing on the computer, the physical document into the electronic document provisioned as digital infrastructure.

### PRIORITY CLAIMS TO RELATED APPLICATIONS

This application is a continuation application of and claims priority to International Patent Application No. PCT/US25/33822 filed Jun. 16, 2025, which claims priority to U.S. Provisional Patent Application No. 63/661,534 filed Jun. 18, 2024, U.S. Provisional Patent Application 63/668,068 filed Jul. 5, 2024, U.S. Provisional Patent Application 63/674,793 filed Jul. 23, 2024, U.S. Provisional Patent Application 63/680,061 filed Aug. 6, 2024, U.S. Provisional Patent Application 63/685,234 filed Aug. 20, 2024, U.S. Provisional Patent Application 63/693,173 filed Sep. 10, 2024, U.S. Provisional Patent Application 63/707,992, filed Oct. 16, 2024, U.S. Provisional Patent Application 63/713,200, filed Oct. 29, 2024, U.S. Provisional Patent Application 63/714,009 filed Oct. 30, 2024, U.S. Provisional Patent Application 63/723,471 filed Nov. 21, 2024, U.S. Provisional Patent Application 63/736,568, filed Dec. 19, 2024, U.S. Provisional Patent Application 63/738,639, filed Dec. 24, 2024, U.S. Provisional Patent Application 63/774,949, filed Mar. 20, 2025, U.S. Provisional Patent Application 63/794,007, filed Apr. 24, 2025, U.S. Provisional Patent Application 63/794,564, filed Apr. 25, 2025, U.S. Provisional Patent Application 63/800,869, filed May 6, 2025, and U.S. Provisional Patent Application 63/822,629 filed Jun. 12, 2025, each of which this application claims benefit to and priority to, and each of which are incorporated herein in their entirety by these references. This application also claims priority to and benefit of U.S. Provisional Patent Application 63/925,068, filed Nov. 25, 2025, U.S. Provisional Patent Application 63/943,892, filed Dec. 12, 2025, U.S. Provisional Patent Application 63/944,143, filed Dec. 12, 2025, U.S. Provisional Patent Application 63/962,034, filed Jan. 16, 2026, U.S. Provisional Patent Application 64/002,016, filed Mar. 10, 2026, and U.S. Provisional Patent Application 64/010,751, filed Mar. 19, 2026, each of which are incorporated herein in their entirety by these references.

### BACKGROUND

Traditional digital document management systems provide limited interoperability between paper documents and their digital documents. Transferring revisions or modifications of paper documents to their digital counterparts is tedious and inefficient. For example, if multiple parties are located in various cities and each party needs to provide their respective physical signature on an original version of a paper document, the physical document needs to be mailed to multiple individuals. Further, each of these individuals will need to provide his or her signature on the document, scan it, and transmit the scanned version to multiple parties. Further, as the physical document is mailed from one party to another, the likelihood of damage to the physical document increases, further lengthening the time it takes to complete one or more transactions. Limited interoperability between physical and digital documents also frustrates the ability of users to track the status of the document, as multiple versions may be present at any given time, with each version including content that may be absent from a different version.

### SUMMARY

In some aspects, the techniques described herein relate to a computer-implemented method comprising receiving, by an application executing on the computer, a request to convert a physical document to an electronic document provisioned as digital infrastructure, and converting responsive to the request, by the application executing on the computer, the physical document into the electronic document provisioned as digital infrastructure.

In some aspects, the techniques described herein relate to a system comprising: a document management hub including at least one physical processor and physical memory comprising computer-executable instructions that, when executed by the at least one physical processor, cause the physical processor to receive, by an application executing on the at least one physical processor, a request to convert a physical document to an electronic document provisioned as digital infrastructure, and convert responsive to the request, by the application executing on the at least one physical processor, the physical document into the electronic document provisioned as digital infrastructure.

In some aspects, the techniques described herein relate to a non-transitory computer-readable medium comprising computer-executable instructions that, when executed by at least one of one or more processors of a computing device, cause the computing device to receive, by an application executing on the computing device, a request to convert a physical document to an electronic document provisioned as digital infrastructure, and convert responsive to the request, by the application, the physical document into the electronic document provisioned as digital infrastructure.

These and other features will be more clearly understood from the following detailed description taken in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 depicts a structure of a self-determinative document;

FIG. 2 can represent an architecture for managing electronic documents as smart digital objects;

FIG. 3 illustrates a flowchart of a method for converting a physical document into an electronic document provisioned as digital infrastructure and facilitating an interaction with the electronic document based on an interaction with the physical document;

FIG. 4A illustrates results of an interaction between an application executing on a computing device and a physical document;

FIG. 4B illustrates the electronic document application associating a new user as a custodian of a physical document;

FIG. 5A illustrates the application enabling content inclusion on an electronic document based on user interaction with a physical document;

FIG. 5B illustrates the application enabling content inclusion on a document based on another user interaction with a physical document;

FIG. 6 illustrates a user interacting with an example physical document within a real-world environment and an artificial reality (AR) based environment;

FIG. 7 depicts an example feature of the electronic document application of the present disclosure;

FIG. 8 illustrates the electronic document application displaying results of a user attempting to print a document provisioned as digital infrastructure; and

FIG. 9 illustrates a scenario in which the document application automatically associates an electronic document provisioned as digital infrastructure with its physical document counterpart upon the application printing the electronic document.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION

Electronic documents, also referred to as digital documents, encompass any form of document stored or accessed using a computer or digital medium. Common formats for electronic documents include PS, PDF, and XPS, among others. These documents are represented digitally as files stored on local drives, shared networks, or cloud-based systems. However, traditional methods of managing electronic documents often result in a loss of control for individuals and entities. This loss of control occurs whether the documents are shared externally with third parties or kept internally within an organization.

For example, when a company hires a new employee and grants them access to proprietary information, the company effectively relinquishes control over that information, typically in the form of electronic documents such as PDFs, spreadsheets, word processing files, and forms. Instead of maintaining actual control, the company relies on pseudo-control mechanisms, such as policies, procedures, and legal agreements. If the employee leaves the company and improperly retains or uses these documents, the company must resort to enforcing employment agreements through the legal system. This may involve attempting to recover or destroy the documents or seeking damages for any harm caused by the former employee's misuse of the information.

Similar scenarios occur daily in commerce and other professional relationships. The proliferation of electronic documents creates a chaotic environment where control is tenuous at best. The primary safeguard against misuse is the legal system, which provides a mechanism for enforcing contractual obligations when improper activity has a significant impact. However, litigation is often expensive, uncertain, and disruptive, encouraging parties to comply with contractual obligations to avoid legal disputes.

For instance, in an unsuccessful M&A transaction, one party may inadvertently retain trade secrets from the other side after the deal falls apart. While retaining these documents may breach material erasure provisions of a non-disclosure agreement, the party is unlikely to share the trade secrets with outsiders due to ethical considerations and the fear of legal repercussions. This reliance on pseudo-control—where compliance is partial and breaches are minor enough to avoid litigation—represents the best outcome achievable under the current system.

In virtually every arms-length transaction, confidential information is shared with the expectation that the legal system and a general aversion to litigation will prevent significant misuse. Whether paying for a sandwich with a credit card, engaging in banking or investment activities, consulting with an attorney, completing a real estate transaction, or working with an accountant to prepare taxes, parties routinely share sensitive information and rely on pseudo-control mechanisms to protect it. This reliance on goodwill and the legal ecosystem underscores the limitations of the current system.

There is a clear need for a system that provides actual control over electronic documents, eliminating dependence on the goodwill of others and the costly, uncertain, and distracting process of legal enforcement. Such a system would ensure that document security and integrity are maintained without relying on external safeguards, enabling more efficient and reliable management of sensitive information in modern digital environments.

Further, as stated, traditional digital document management systems lack interoperability between paper and digital documents. Transferring modifications or revisions from paper documents to their digital counterparts is tedious, time and resource intensive, and inefficient. In cases where multiple individuals located in various cities need to provide their physical signatures on a document, each individual needs to sign, scan, and then transmit the scanned document to other individuals. While the paper document may be mailed from one user to another, there are multiple digital versions of the paper document. In other words, there is no single digital version that mirrors the information included in the paper document. Further, mailing a physical document from one location to another increases the likelihood of damage and the potential loss of the physical document.

The systems and methods disclosed herein address one or more of the challenges identified above by introducing a transformative way of increasing interoperability between physical documents and their digital counterparts. In particular, this approach involves the use of an application that efficiently transfers modifications from a physical document to its digital counterpart without requiring an exchange of multiple digital versions of the physical document. In fact, multiple instances of the application, executing on devices of users that may be hundreds of miles apart, may include representations of handwritten signatures provided on a paper document onto an electronic version of the document, automatically and approximately in real time. As such, interoperability between physical and digital documents is increased and the deficiency in traditional systems of uploading multiple digital versions of a particular physical document is addressed and overcome.

Self-determinative documents may be designed to maintain control over their lifecycle, access, and interactions, reducing the reliance on pseudo-control mechanisms such as policies, procedures, and legal agreements. By embedding intelligence directly within the document, the embodiments of this disclosure may provide a robust framework for ensuring security, integrity, and compliance, even when documents are shared externally or distributed across various platforms. This embedded intelligence also accesses data related to various parts of these documents to generate a visual layout presentation framework that significantly simplifies the process of identifying a document of interest, thereby resolving the traditional deficiencies relating to document searching.

Further, traditional methods of managing electronic documents often result in a loss of control once the document is shared, as highlighted in the example of a company granting an employee access to proprietary information. The systems and methods disclosed herein may address this problem by provisioning documents with embedded intelligence, such as an integrated API or software chip, which allows the document to autonomously enforce access permissions and track interactions. For instance, a self-determinative document containing sensitive company data can restrict access to authorized users only, even if the document is shared externally. If an employee leaves the company, the document can revoke their access in real-time, ensuring that proprietary information remains secure without requiring legal intervention.

In addition, self-determinative documents have one or more of a variety of attributes and advantages that enable them to address the drawbacks of traditional documents. These include dynamic access control, the ability to be a single source of truth, enhanced security and confidentiality, streamlined collaboration and compliance, universal accessibility, integrity and availability, true ownership, empowering ownership transitions, and enabling a universal frictionless system of record. The advantages of self-determinative documents are further improved when operating as part of and in collaboration with a document management hub. These include an improved visual layout framework for presenting document search results, advanced search result filtering, automatic and seamless content propagation, and efficient workflow management. These and other features and advantages enable a world that is transformed by self-determinative documents.

Self-determinative documents replace static, policy-based control with dynamic, real-time access management. For example, in the context of an M&A transaction, a self-determinative document containing trade secrets can enforce strict access permissions based on user roles and security clearances. The document can also log all interactions, providing a comprehensive audit trail that ensures compliance with non-disclosure agreements. Unlike traditional systems that rely on the goodwill of parties to comply with contractual obligations, the embedded intelligence within the document autonomously enforces these obligations, reducing the risk of misuse and eliminating the need for costly and uncertain litigation.

Self-determinative documents may provide robust security features, such as encryption, role-based access control, and multi-factor authentication, to protect sensitive information. For instance, in a real estate transaction, a self-determinative document can ensure that only authorized parties, such as the buyer, seller, and their respective attorneys, can access specific sections of the document. The document can also enforce time-limited access, revoking permissions automatically after the transaction is completed. This level of control eliminates the reliance on external safeguards and ensures that confidential information remains protected.

Self-determinative documents may excel in the metrics of integrity and availability due to their built-in intelligent features, setting them apart from traditional PDFs. Confidentiality is ensured through robust access control mechanisms, such as role-based permissions, multi-factor authentication, and encryption, which prevent unauthorized users from viewing or interacting with the document. Integrity is maintained by embedding intelligence within the document, allowing it to autonomously track changes, log interactions, and enforce version control, ensuring that the document remains authentic and tamper-proof throughout its lifecycle. Availability is enhanced by storing a single authoritative version of the document in a secure, centralized location, accessible from anywhere and across various devices. Unlike traditional PDFs, which are static and prone to duplication, self-determinative documents dynamically manage access and interactions, ensuring that they remain secure, reliable, and accessible at all times. This combination of features makes self-determinative documents a superior solution for modern document management challenges.

Self-determinative documents may enable true ownership by embedding intelligence directly within the document, allowing the owner to maintain control over its lifecycle, access, and interactions, independent of the computer or system storing it. Unlike traditional digital documents, which are tied to the device or platform where they are stored and can be easily copied or modified without the owner's consent, self-determinative documents are designed to enforce ownership rights autonomously. The embedded intelligence ensures that the document's owner can define and enforce access permissions, revoke or grant access in real-time, and track all interactions with the document, regardless of where it is stored or accessed. This capability eliminates the reliance on external systems or legal constructs to maintain control, providing a robust framework for secure and reliable document management. By enabling true ownership, self-determinative documents empower individuals and organizations to protect their sensitive information and ensure compliance with policies and agreements, even in complex digital environments.

A self-determinative document can have immutable content, meaning that the core data of the document cannot be altered once it has been finalized or authenticated. This immutability ensures that the document remains in its original, unmodified state, preserving its integrity and trustworthiness throughout its lifecycle. Achieved through cryptographic techniques such as hashing or digital signatures, immutable content creates a unique fingerprint of the document's data, making any unauthorized modifications detectable and invalidating the document's authenticity. Additionally, embedded executable code within the document can autonomously track and prevent unauthorized changes, further reinforcing its immutability.

The advantages of immutable content are numerous and impactful across various industries and applications. Enhanced security and integrity are among the most significant benefits, as immutable content protects sensitive documents-such as contracts, legal agreements, medical records, and financial reports-from tampering or unauthorized edits. Immutable content also preserves provenance and authenticity, ensuring that the document's original state is traceable and verifiable, which is critical for legal proceedings and regulatory compliance. For example, immutable medical records can demonstrate adherence to HIPAA regulations by providing a tamper-proof history of patient data. Fraud prevention is another key advantage, as immutable content eliminates the risk of altering critical information, such as payment details in invoices, safeguarding both parties in financial transactions. Furthermore, immutable content simplifies version control by maintaining the original document intact while allowing changes to be appended as metadata or separate layers, ensuring transparency and accountability in collaborative workflows.

In decentralized systems, such as distributed ledger-based environments, immutable content guarantees consistency and trustworthiness across all nodes, making it ideal for applications like smart contracts. Long-term preservation is also enhanced, as immutable content ensures that historical records remain reliable and accessible over time, even as technology evolves. This is particularly valuable for archival purposes, where government records or other historical documents must be preserved in their original state.

Immutable content also facilitates efficient dispute resolution by providing an unaltered reference point for resolving conflicts, such as confirming agreed-upon terms in business negotiations. Additionally, it improves user confidence by assuring the authenticity and reliability of the document, which is especially important in digital transactions. Overall, the immutability of content in self-determinative documents is a cornerstone of their reliability and security, offering enhanced integrity, trust, and compliance across a wide range of applications in legal, financial, healthcare, and government contexts.

A self-determinative document can have immutable machine-readable content, meaning that the core data of the document is encoded in a format that cannot be altered once it has been finalized or authenticated and that the content can be read by a computer. As discussed above, this immutability ensures that the document remains in its original, unmodified state, preserving its integrity and trustworthiness throughout its lifecycle. Machine-readable content refers to data that is structured in a way that can be directly processed by computers, such as JSON, XML, or binary formats, enabling advanced computational interactions and automated workflows. When combined with immutability, this content becomes a powerful tool for ensuring security, traceability, and reliability in digital ecosystems.

The immutability of machine-readable content is achieved through cryptographic techniques such as hashing or digital signatures. Hashing generates a unique fingerprint of the document's data, ensuring that even the smallest unauthorized modification can be detected. Digital signatures, created using public/private key pairs, authenticate the document's origin and verify its integrity. Together, these techniques make unauthorized changes detectable and invalidate the document's authenticity if tampering occurs. Additionally, embedded executable code within the document can autonomously track and prevent unauthorized changes, further reinforcing its immutability. This embedded intelligence ensures that the document can actively monitor its own integrity, providing an additional layer of security.

The advantages of immutable machine-readable content are numerous and impactful across various industries and applications. Immutable machine-readable content also simplifies version control by maintaining the original document intact while allowing changes to be appended as metadata or separate layers. This approach ensures transparency and accountability in collaborative workflows, as all modifications are clearly documented without altering the original content.

In decentralized systems, such as distributed ledger-based environments, immutable machine-readable content guarantees consistency and trustworthiness across all nodes. This makes it ideal for applications like smart contracts, where the integrity of the contract terms must be preserved across a distributed network. Long-term preservation is another key advantage, as immutable content ensures that historical records remain reliable and accessible over time, even as technology evolves. This is particularly valuable for archival purposes, where government records or other historical documents must be preserved in their original state to maintain their authenticity and legal validity.

The machine-readable nature of immutable content further enables advanced computational interactions, such as automated compliance checks, semantic analysis, and AI-driven insights. For instance, a legal document encoded in a machine-readable format can be automatically analyzed to ensure compliance with regulatory requirements, flagging any discrepancies or missing clauses. Similarly, a financial report can be processed by AI systems to generate real-time analytics, providing valuable insights into trends and anomalies. These capabilities are made possible by the structured and immutable nature of the content, which ensures that the data remains consistent and reliable throughout its lifecycle.

Overall, the immutability of machine-readable content in self-determinative documents can be a cornerstone of their reliability and security. It offers enhanced integrity, trust, and compliance across a wide range of applications in legal, financial, healthcare, and government contexts. By combining the benefits of immutability with the computational power of machine-readable formats, these documents redefine the standards for security, transparency, and efficiency in digital ecosystems, paving the way for a future where information is universally trustworthy and accessible.

Self-determinative documents enable stateful AI by embedding intelligence directly within the document, allowing it to maintain context, identity, and a persistent record of its interactions. Unlike prior AI solutions, which often rely on fragmented or static data sources, self-determinative documents provide a unified, dynamic, and machine-readable structure that preserves the document's lifecycle, metadata, and relationships with other entities. This persistent state allows AI systems to achieve a higher level of inference, as they can access not only the document's content but also its history, provenance, and contextual relevance. For example, a self-determinative document can record every interaction it has undergone, such as edits, approvals, or access attempts, and make this information available to AI systems for analysis. This enables the AI to infer patterns, predict outcomes, and provide insights that are far more nuanced and accurate than those derived from static or disconnected data.

In contrast, prior AI solutions often operate on isolated datasets or snapshots of information, limiting their ability to understand the broader context or draw deep conclusions. These systems typically require extensive preprocessing to integrate disparate data sources, and even then, they may lack the ability to track changes or maintain continuity over time. For instance, an AI analyzing a traditional contract might only have access to the text of the document, without any knowledge of its revision history, associated workflows, or related agreements. This lack of statefulness restricts the AI's ability to make informed decisions or provide meaningful recommendations.

Self-determinative documents overcome these limitations by serving as active participants in the AI ecosystem. Their embedded intelligence ensures that all relevant data—whether it pertains to the document's content, metadata, or interactions—is readily accessible and consistently updated. This enables AI systems to perform advanced reasoning, such as identifying dependencies between documents, detecting anomalies in workflows, or simulating counterfactual scenarios. For example, an AI analyzing a portfolio of contracts can use the stateful nature of self-determinative documents to understand how changes in one agreement might impact others, predict compliance risks, or recommend optimizations.

The ability to maintain state also enhances the AI's capacity for personalization and contextual adaptation. By understanding the document's history and the roles of its users, the AI can tailor its responses and actions to the specific needs of each stakeholder. For instance, in a collaborative environment, the AI can prioritize tasks based on the document's workflow history or provide targeted recommendations based on the user's previous interactions. This level of inference is unattainable with prior AI solutions that lack access to a persistent and unified data structure.

Overall, self-determinative documents transform AI from a reactive tool into a proactive and deeply insightful system. By providing a stateful foundation, these documents enable AI to achieve a higher level of inference, bridging the gap between static data processing and dynamic, context-aware reasoning. This advancement not only enhances the accuracy and relevance of AI-driven insights but also unlocks new possibilities for automation, decision-making, and innovation across industries.

The transition to a world dominated by self-determinative documents marks a significant shift in how individuals and organizations interact with digital information. For example, the reliance on paper documents diminishes significantly in a self-determinative document world. Traditional paper-based workflows, such as printing, signing, and scanning, are replaced by digital processes that leverage embedded intelligence and biometric authentication. For instance, contracts and agreements can be signed electronically using facial recognition or fingerprint scans, eliminating the need for physical signatures. Self-determinative documents can autonomously verify the authenticity of these biometric inputs, ensuring that the signing process is secure and tamper-proof. This reduction in paper usage not only streamlines workflows but also contributes to environmental sustainability by minimizing waste and resource consumption.

One of the most noticeable changes may be the reduction in the use of traditional input methods, such as keyboards. Self-determinative documents, equipped with embedded intelligence and dynamic interfaces, allow users to interact with documents through voice commands, gestures, and AI-driven prompts. For example, instead of typing lengthy edits or comments, users can verbally instruct the document to make changes, with the embedded intelligence processing and executing these commands in real-time. This shift not only enhances efficiency but also makes document interaction more intuitive and accessible, particularly for individuals with physical limitations or those working in environments where traditional input devices are impractical.

As self-determinative documents become the standard, traditional signatures may increasingly be replaced by AI-driven and biometric interactions. Embedded intelligence within the document can analyze and authenticate biometric data, such as voice patterns, facial features, or fingerprints, to confirm user identity and authorize actions. AI further enhances this process by providing contextual insights and recommendations, such as suggesting edits, highlighting discrepancies, or automating repetitive tasks. For example, a self-determinative document used in a legal setting can flag clauses that require attention or suggest alternative language based on prior agreements. These advancements reduce reliance on manual processes and foster a more seamless and secure interaction with digital documents, paving the way for a future where document management is driven by intelligence and innovation.

In a post-PDF world dominated by self-determinative documents, the advantages extend to improving operational efficiency and reducing human error. For example, in industries such as healthcare, self-determinative documents can autonomously update patient records based on real-time inputs from medical devices or lab results. This eliminates the need for manual data entry, reducing errors and ensuring that healthcare providers have access to the most accurate and up-to-date information. Similarly, in logistics, self-determinative shipping manifests can dynamically adjust based on inventory changes or delivery schedules, streamlining operations and minimizing delays.

Another advantage is the ability to enforce granular access control and compliance across diverse environments. For instance, in financial services, self-determinative documents can restrict access to sensitive sections of a report based on user roles, such as allowing auditors to view transaction details while limiting access for junior staff. The embedded intelligence within the document ensures that compliance with regulatory requirements, such as GDPR or HIPAA, is maintained without the need for constant oversight. This capability is particularly valuable in industries where data security and privacy are critical.

Self-determinative documents also enhance collaboration by enabling real-time interaction among multiple users. For example, during the drafting of a legal contract, stakeholders can simultaneously edit and comment on the document, with changes tracked and logged by the embedded intelligence. This eliminates the need for back-and-forth email exchanges and ensures that all parties are working on the same version of the document. Additionally, the document can provide insights into the collaboration process, such as identifying sections that require further discussion or highlighting areas of agreement.

The ability to integrate with artificial intelligence (AI) systems further amplifies the advantages of self-determinative documents. For example, in marketing, AI-driven self-determinative documents can analyze user engagement data to suggest improvements to campaign strategies. A marketing report might highlight trends in customer behavior or recommend adjustments to ad placements based on real-time analytics. In education, self-determinative documents can adapt their content based on student performance, providing personalized learning experiences that cater to individual needs.

Another transformative advantage is the ability to create tiered access systems that align with business models. For instance, a subscription-based service can use self-determinative documents to offer different levels of access to content based on subscription tiers. A basic subscriber may access summary reports, while premium subscribers can view detailed analytics and proprietary insights. This flexibility allows businesses to monetize their content effectively while maintaining control over its distribution.

Finally, self-determinative documents may contribute to building trust and transparency in digital interactions. By maintaining a single authoritative version and providing detailed audit trails, these documents ensure that all interactions are traceable and verifiable. For example, in supply chain management, self-determinative documents can track the provenance of goods, ensuring that stakeholders have confidence in the authenticity and quality of products. This capability is particularly valuable in industries such as pharmaceuticals or luxury goods, where trust and transparency are paramount.

In summary, the post-transition world of self-determinative documents offers a wide range of advantages, from operational efficiency and enhanced collaboration to improved security, personalization, and environmental sustainability. By leveraging embedded intelligence and dynamic capabilities, these documents transform the way individuals and organizations manage, interact with, and derive value from digital information.

The analogy of city infrastructure provides a compelling way to understand the transformative role of dynamic, intelligent documents as foundational elements in digital ecosystems. Just as a city relies on essential infrastructure like electricity, water, roads, and telecommunications to support its operations and enable the development of services and businesses, these advanced documents serve as the foundational infrastructure for modern information management, enabling a wide range of applications and services to be built on top of them. Imagine a bustling city. At its core, the city operates on a network of infrastructure systems that are invisible to most residents but are critical to its functioning. Electricity powers homes, businesses, and public spaces, while water systems ensure clean drinking water and sanitation. Roads and transportation networks connect neighborhoods, allowing people and goods to move efficiently.

Telecommunications infrastructure enables communication, commerce, and access to information. These systems are not the end goal themselves; rather, they are the foundation upon which the city's economy, culture, and daily life thrive. Similarly, intelligent documents act as the infrastructure for digital ecosystems. They are not merely static files or isolated records; they are dynamic, interactive entities that provide the foundational capabilities needed for modern workflows, compliance, and collaboration. Just as a city's infrastructure supports diverse activities like commerce, education, and healthcare, these documents enable a wide range of services, including verification, authentication, workflow automation, auditing, and data analysis.

In a city, the presence of reliable infrastructure allows businesses and services to flourish. For example, a restaurant relies on electricity to power its kitchen appliances, water for cooking and cleaning, roads for food deliveries, and telecommunications for online orders and customer communication. Without this infrastructure, the restaurant would struggle to operate efficiently or scale its services. In the digital world, intelligent documents provide similar foundational support. Consider a legal firm managing contracts. These documents enable the firm to automate workflows, such as tracking contract revisions, managing access permissions, and ensuring compliance with regulatory requirements.

The firm can build services like automated contract review, real-time collaboration, and secure sharing on top of the document infrastructure. These services are analogous to the restaurant's reliance on city infrastructure-they are made possible by the foundational capabilities of these advanced documents.

Cities often expand their infrastructure to accommodate growth and new opportunities. For instance, a city might build a new subway line to connect previously inaccessible neighborhoods, enabling economic development and improving residents' quality of life. This expansion creates new possibilities for businesses, housing, and cultural activities. Intelligent documents similarly enable expansion in digital ecosystems. For example, an enterprise might integrate these documents into its customer relationship management (CRM) system. This integration allows the CRM to access real-time data from contracts, invoices, and other records, enabling advanced analytics and personalized customer interactions. Just as a new subway line connects neighborhoods, these documents connect disparate systems, breaking down silos and enabling seamless communication and collaboration.

City infrastructure is designed to be resilient and adaptable, ensuring that it can withstand challenges like natural disasters or population growth. For example, a city might upgrade its water system to handle increased demand or reinforce its electrical grid to prevent outages during storms. Intelligent documents offer similar resilience and adaptability in digital ecosystems. They are designed to be immutable, ensuring the integrity and trustworthiness of their content. At the same time, they are dynamic, allowing for real-time updates, granular access control, and integration with emerging technologies like artificial intelligence. This adaptability ensures that these documents can evolve alongside the needs of organizations, just as city infrastructure evolves to meet the needs of its residents.

The city infrastructure analogy illustrates the foundational role of intelligent documents in digital ecosystems. Just as a city's infrastructure supports the development of services, businesses, and communities, these documents provide the capabilities needed for modern workflows, compliance, and collaboration. They enable organizations to build services, expand their capabilities, and adapt to changing needs, creating a robust and interconnected digital environment. This analogy underscores the transformative potential of these documents as the infrastructure for the future of information management.

Documents as infrastructure enable a wide range of new services and workflows that transform traditional document management into dynamic, interactive, and automated processes. For instance, automated contract review becomes possible as documents as infrastructure autonomously analyze clauses, flag discrepancies, and suggest edits based on predefined rules or past agreements, streamlining legal workflows. Real-time collaboration is enhanced as multiple users can simultaneously edit, comment, and interact with a single authoritative version of a document, with all changes tracked and logged. Dynamic access control ensures sensitive information is protected by enforcing granular permissions based on user roles, security clearances, or contextual conditions. Audit trail generation is seamlessly integrated, as documents as infrastructure automatically record all interactions, including edits, views, and shares, creating a comprehensive log for compliance and regulatory purposes.

Version management is simplified, as documents as infrastructure maintain a timeline of changes, allowing users to access previous versions or compare differences without duplicating files. Embedded applications hosted within these documents enable users to perform complex tasks, such as calculations, data visualizations, or form-filling, directly within the document itself. Workflow automation is another key capability, as documents as infrastructure can trigger actions like sending notifications, initiating approvals, or updating related systems based on predefined rules or user interactions. Secure sharing is facilitated by enforcing restrictions, such as requiring recipients to sign an NDA or authenticate their identity before accessing the content. Data synchronization ensures that documents as infrastructure integrate seamlessly with external databases or systems, keeping their content up-to-date and consistent across platforms.

Dynamic rendering allows documents as infrastructure to adapt their layout and content based on the user's device, role, or preferences, providing an optimized viewing experience. Content personalization further enhances usability by tailoring the document's content to individual users, such as displaying different sections based on user roles or preferences. Compliance verification is automated, as documents as infrastructure autonomously check their content against regulatory requirements, flagging non-compliance and suggesting corrections. Lead generation is supported by enabling documents shared externally to collect user information, such as names and emails, before granting access, creating opportunities for marketing and sales. Data analytics capabilities allow documents as infrastructure to aggregate and analyze metadata, providing insights into user behavior, engagement patterns, and workflow efficiency.

Documents as infrastructure also establish relationships with other documents, such as linking contracts to appendices or invoices to purchase orders, enabling seamless navigation and contextual understanding. Content redaction is automated, allowing sensitive information to be hidden based on access permissions or user-defined rules, ensuring confidentiality. Offline access is supported, enabling users to securely interact with documents as infrastructure even when disconnected, while maintaining synchronization with the authoritative version upon reconnection. Ownership transition is facilitated, as documents as infrastructure can transfer ownership or permissions to designated successors upon predefined conditions, such as the death of the original owner. Dynamic notifications keep users informed of updates, deadlines, or required actions, ensuring timely responses and efficient workflows.

Finally, documents as infrastructure integrate seamlessly with AI systems, enabling contextual insights, automating repetitive tasks, and answering queries based on their content and metadata. These capabilities collectively transform documents from static files into dynamic infrastructure, revolutionizing workflows, enhancing collaboration, and unlocking new opportunities for automation and efficiency.

The systems and methods disclosed herein represent a transformative advancement in the management and interaction with hard copies, addressing longstanding inefficiencies and security vulnerabilities inherent in traditional systems such as PDFs and other prior document technologies. While PDFs have served as a widely adopted standard for digital documents, they are fundamentally limited in their ability to maintain control, enforce security, and facilitate seamless interaction with physical counterparts. PDFs often rely on external systems for encryption, access control, and version management, leaving them vulnerable to unauthorized modifications, fragmented audit trails, and inefficient workflows. Moreover, once a PDF is printed, the resulting hard copy becomes disconnected from its digital counterpart, creating challenges in tracking, verifying, and managing the lifecycle of the physical document.

The systems disclosed herein may overcome these limitations by introducing hard copy control mechanisms integrated into smart documents provisioned as digital infrastructure. These smart documents may feature immutable content, an immutable audit trail, and an immutable global identifier, ensuring that both the digital and physical versions of the document remain tamper-proof, traceable, and trustworthy. Unlike PDFs, which lose control over their printed versions, the disclosed systems embed unique identifiers, such as QR codes or invisible machine-readable markers, into each printed copy. These identifiers link the hard copy back to its authoritative digital counterpart, enabling real-time tracking, verification, and interaction. For example, a printed document can be scanned to update its digital audit trail, incorporate handwritten annotations, or enforce access permissions, ensuring that the physical and digital versions remain synchronized and secure.

Additionally, the disclosed systems may leverage embedded intelligence within the smart document to autonomously manage interactions with hard copies. This includes controlling printing privileges, issuing warnings about security risks associated with printing, and recording printing events in the document's audit trail. By integrating these capabilities directly into the document infrastructure, the systems eliminate the need for external tools or manual processes, streamlining workflows and enhancing security. Furthermore, the machine-readable design of a smart document may enable lightweight, API-driven interactions with hard copies, reducing the computational and network overhead associated with traditional PDF systems.

Thus, the systems and methods for controlling and interacting with hard copies disclosed herein represent an improvement over PDFs and other prior systems. By combining immutability, embedded intelligence, and machine-readable design, these systems ensure that both digital and physical documents are securely managed, seamlessly integrated, and dynamically interactive. This paradigm shift not only addresses the limitations of traditional document technologies but also unlocks new possibilities for efficient and secure document management in modern digital ecosystems.

The following detailed description provides an in-depth explanation of the systems, methods, and interfaces for modifying digital content in documents and gathering information about documents by communicating directly with these documents. Further, these documents are smart documents with embedded intelligence that enables them to manage and track their lifecycle, interactions, and security. This disclosure enumerates how self-determinative documents and a document management hub facilitate the simultaneously modification of various parts of electronic documents via editing digital content instances that are linked directly to sole authoritative versions of these documents. Further, by leveraging advanced features such as in-documents applications-software applications embedded as part of and which reside within the environments of these documents-users can communicate with other documents directly from a particular document and gather a wide variety of data about these documents, e.g., amount of time a user spent reviewing a particular part of these documents, the number of users that may have reviewed these documents over a time interval, the type of changes made to these documents, and so forth. The embodiments described herein are intended to be illustrative and not restrictive, allowing for modifications and enhancements to meet evolving needs.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

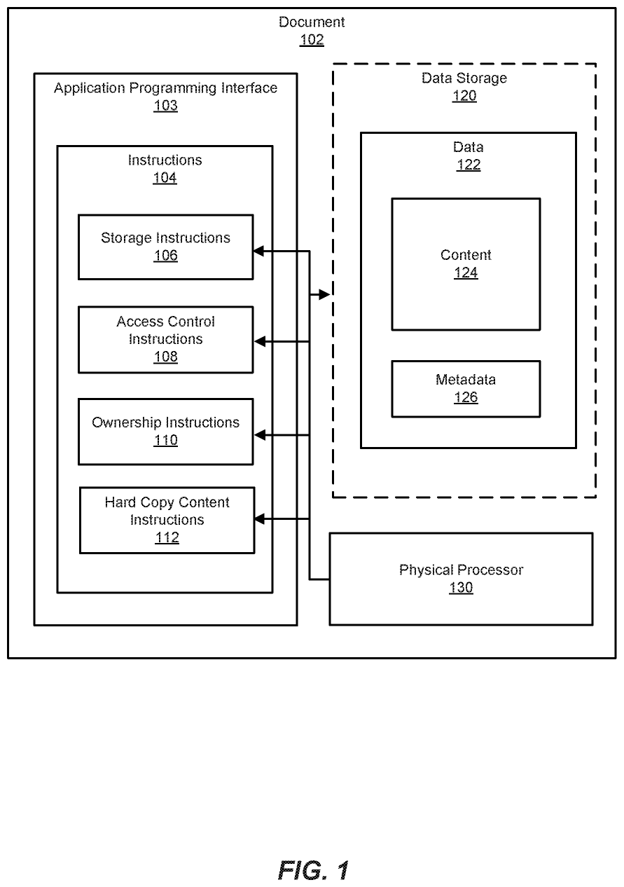

FIG. 1 depicts a structure of a self-determinative document. The self-determinative document 102 (interchangeably referenced in this disclosure as the electronic document 102 or the document 102) serves as digital infrastructure that integrates various interfaces and components to manage various aspects of the document, e.g., access to the document, editing the document, sharing the document, and so forth. Provisioned as digital infrastructure, the document 102 includes an application programming interface (API) 103 (referred to herein interchangeably as “API,” “application programming interface,” API 103) with instructions 104. The instructions 104 play an important role in the operation of the electronic document 102, namely providing the necessary connections between the document 102 and its various functionalities. These instructions 104 include the storage instructions 106, access control instructions 108, ownership instructions 110, and hard copy content instructions 112. Each set of instructions is responsible for a specific aspect of the document's functionality, ensuring that data is stored securely, access is controlled, ownership is maintained, and trust is established.

The storage instructions 104 are responsible for managing the storage of data within the document 102. The storage instructions 104 interact with the data storage 120 to ensure that data 122 is stored efficiently and securely. The storage instructions 104 facilitates the retrieval and updating of data 122, allowing the document 102 to maintain a single true copy and ensuring consistency across all accessed versions. These storage instructions 104 play an important role in the document's ability to provide dynamic content rendering and real-time updates.

The access control instructions 108 manage who can access the data within the document 102. These instructions determine whether an entity is allowed to access the document 102 and control access based on predefined rules and permissions. By ensuring that only authorized users can interact with the document 102, the access control instructions 108, when executed, provide a secure environment for document management. The access control instructions 108 are essential for the document's capability to enable secure sharing and collaboration among multiple users with varying access levels. Further, these instructions, when executed, ensure that multiple authorized users may simultaneously access and revise one or more parts of the document 102 such that the revisions appear on respective users interfaces of various devices associated with these users.

The ownership instructions 110 are designed to maintain control over the document 102, even when shared with third parties. This interface enables the document's owner to manage ownership rights and control the distribution of the document 102. This feature is important for ensuring that the document's ownership is preserved and that the document 102 can be linked to a specific context in which the document 102 was shared. The ownership instructions 110 provides the document's owner with the ability to revoke access or grant temporary access as needed.

The hard copy content instructions 112 are responsible for facilitating interoperability between physical documents and their digital counterparts. For example, the hard copy content instructions 112 can be accessed via a number of other devices different from the memory of the device in which the single authoritative version of an electronic document, the document 102, are stored. Further, the hard copy content instructions 112 enable, upon execution by one or more instances of an electronic document application executing on various users' devices, users to interact with a physical document in order to modify the subject matter of the electronic document linked to the physical document. For example, the electronic document application, in part based on the execution of the hard copy control instructions 112, transfers the handwritten signatures provided by multiple individuals on a physical document, automatically and approximately in real time, onto a single electronic version of the physical document.

The data storage 120 supports the document 102, offering a secure location for storing data 122. The data storage 120 operates in conjunction with the storage instructions 104 to ensure that data is stored in an efficient and secure manner. The design of the data storage 120 maintains a single true copy of the document 102, ensuring consistency across all accessed versions. Data storage for self-determinative documents can be implemented in various configurations, including a single cloud-based server, distributed across multiple servers or devices, or within an on-premises system, each offering distinct advantages based on scalability, security, accessibility, and compliance needs. In a single cloud-based server setup, the data storage is hosted on centralized platforms like Amazon Web Services (AWS) or Microsoft Azure, ensuring that the document and its associated data are stored securely and accessible globally.

This configuration is ideal for organizations prioritizing scalability and disaster recovery, as it allows employees across regions to access the most up-to-date version of the document without duplicating or fragmenting the data. The data storage 120 refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

Alternatively, a distributed storage model spans multiple servers or devices, creating a decentralized system that ensures redundancy, fault tolerance, and localized access. For example, financial institutions may store documents across geographically dispersed servers to minimize latency and ensure high availability, often leveraging technologies like blockchain to maintain tamper-proof authenticity and traceability. On-premises systems, where data storage is hosted entirely within an organization's local infrastructure, can provide maximum control and security, making them ideal for handling sensitive or regulated data, such as patient medical records or classified government documents. This setup ensures compliance with privacy regulations and eliminates reliance on external internet connectivity, allowing uninterrupted access even in environments with limited network availability.

A hybrid storage model combines cloud-based and on-premises systems, enabling organizations to store sensitive data locally while leveraging cloud platforms for less critical data or global access. For instance, a government agency might store classified documents on-premises while using cloud storage for public-facing reports, balancing scalability with compliance. Regardless of the configuration, the design of the data storage ensures that the document maintains a single true copy, preventing duplication or fragmentation of data. Synchronization protocols, cryptographic techniques, and metadata tracking ensure consistency across all accessed versions, while security measures like encryption and access controls protect the data from unauthorized access or tampering. By leveraging these flexible storage options, organizations can confidently manage their self-determinative documents in a manner that aligns with their operational, security, and compliance requirements.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

The data 122 stored within the data storage 120 represents the content of the document 102. The data 122 is managed by the storage instructions 106 and is subject to the access control instructions 108, ownership instructions 110, and hard copy control instructions 112. The data 122 serves as a central component of the document's functionality, providing the information that users and other entities interact with and manage through the document's application programming interface 103.

The data of a self-determinative document can include two distinct components: content 124 and metadata 126, each serving a unique purpose in the document's functionality and lifecycle. Content 124 refers to the core information of the document, such as text, images, tables, or other embedded elements that constitute the primary substance of the document. This content is immutable, meaning it cannot be altered once the document has been finalized or authenticated. The immutability of content 124 ensures the integrity and trustworthiness of the document, making it suitable for applications where the original state of the document must be preserved, such as legal agreements, financial reports, or medical records.

On the other hand, metadata 126 represents supplementary information about the document, such as timestamps, user interactions, access logs, version history, or contextual details. Unlike the immutable content, metadata 126 is mutable and can be updated or modified as the document evolves. For example, metadata can record the identity of users who accessed the document, the time and date of interactions, or the addition of comments or annotations. This mutability allows the document to dynamically track its lifecycle and provide real-time insights into its usage and provenance. By separating immutable content from mutable metadata, the document achieves a balance between preserving its core integrity and enabling flexibility for operational and contextual updates. This dual structure ensures that the document remains both reliable and adaptable, meeting the needs of secure and dynamic digital environments.

Metadata plays a central role in the functionality and transformative potential of smart documents (i.e., documents that are digital infrastructure). It provides a structured, machine-readable layer of information that goes beyond the visual representation of a document, enabling advanced computational interactions, dynamic workflows, and granular access control. Metadata can be categorized into several distinct types, each serving a unique purpose in enhancing the utility and intelligence of a document. These categories include process metadata, semantic metadata, and content-related metadata, among others. Below is a detailed explanation of these metadata types, with examples drawn from the discussion.

Process metadata captures the history and lifecycle of a document, recording every action, interaction, and workflow the document has undergone. This type of metadata serves as an audit trail, providing a comprehensive record of the document's journey and the processes it has been part of. For example, process metadata might include timestamps for when the document was created, edited, shared, or signed. It can also log the identities of users who accessed the document, the nature of their interactions (e.g., viewing, commenting, or editing), and any changes made to the document's content or metadata.

Consider a scenario involving a contract document. The process metadata for this document might include a log of when the contract was drafted, when it was sent to a client for review, and when it was signed by both parties. It might also record any amendments made to the contract, along with the identities of the individuals who made those changes. This metadata provides a transparent and unambiguous record of the document's lifecycle, which is invaluable for compliance, auditing, and dispute resolution.

Another example is a receipt document. The process metadata for a receipt might include information about when the receipt was issued, when it was submitted for reimbursement, and when it was approved by the finance department. This metadata ensures that the document's history is traceable and verifiable, reducing the risk of errors or fraud.

Semantic metadata describes the intrinsic characteristics of a document, answering the question of “what the document is” rather than “what the document contains.” This type of metadata includes information about the document's type, ownership, and categorical classification. For example, semantic metadata might indicate that a document is an NDA (Non-Disclosure Agreement), a marketing presentation, or a financial report. It might also specify the document's owner, such as the individual or organization responsible for its creation and management.

Semantic metadata is particularly useful for organizing and categorizing documents within a system. For instance, in an enterprise setting, semantic metadata can be used to group all contracts under a “Legal Documents” category, all invoices under a “Finance Documents” category, and all marketing materials under a “Marketing Documents” category. This categorization enables efficient search and retrieval, as users can query the system to find all documents of a specific type or category.

An example provided in the discussion involves an NDA document. The semantic metadata for this document might include fields specifying the parties involved, the date the agreement was signed, and the expiration date of the confidentiality obligations. This metadata not only categorizes the document but also enriches it with contextual information that is directly related to its purpose and use.

Content-related metadata provides a structured representation of the document's content, breaking it down into machine-readable elements such as paragraphs, headings, tables, and images. This type of metadata enables advanced computational interactions with the document, such as semantic analysis, automated workflows, and dynamic rendering.

For example, a marketing presentation might include content-related metadata that identifies the title slide, the key points in each section, and the images used to illustrate the presentation. This metadata allows the document to be rendered dynamically based on the user's device or context. On a mobile phone, the presentation might be displayed as a series of concise bullet points, while on a desktop, it might be shown in its full layout with detailed graphics.

Another example is a financial report. The content-related metadata for this document might include tags for each section, such as “Executive Summary,” “Revenue Analysis,” and “Expense Breakdown.” These tags enable users to navigate the document efficiently and allow the system to extract specific sections for use in other workflows or applications.

One aspect of metadata in documents that are digital infrastructure is its bidirectional relationship with the document itself. Changes to the metadata can directly modify the document, and updates to the document can automatically update the metadata. This dynamic interaction ensures that the document and its metadata remain consistent and synchronized.

For example, if the due date for a receipt is updated in the metadata, the document itself might display a notification or highlight the updated due date. Conversely, if a user adds a comment to a document, the metadata might be updated to include information about the comment, such as the timestamp and the identity of the commenter. This bidirectional relationship enhances the document's utility and ensures that all changes are accurately reflected across its metadata and content.

The discussion provided several compelling examples of how metadata can be used to enrich and enhance documents:

Dynamic Forms: Metadata can specify fields that need to be filled within a document, such as names, dates, and signatures. For example, an NDA document might include metadata fields for the names of the parties involved and the date of signing. These fields can be dynamically updated based on user input, ensuring that the document remains accurate and complete.

Action Logs: Metadata can record actions that need to be performed with a document, such as submitting it for approval or attaching supporting documents. For instance, a receipt might include metadata specifying that it needs to be submitted to the finance department by a certain date.

Queryable Data: Metadata enables documents to be fully queryable, allowing users to retrieve information efficiently. For example, a user might query the system to find all receipts above $10 or all contracts signed in the last year. This capability transforms documents into active, searchable entities.

Multi-Document Data Layer: Metadata from multiple documents can be aggregated into a centralized database, enabling cross-document queries and analysis. For example, an enterprise might use this data layer to analyze spending patterns across all receipts or identify trends in contract negotiations.

Metadata can be the backbone of smart documents, providing the structure and intelligence needed to transform them from static files into dynamic, interactive entities. By capturing process history, semantic characteristics, and content structure, metadata enables advanced computational interactions, efficient organization, and seamless workflows. The examples provided illustrate the versatility and power of metadata, highlighting its role in creating a new paradigm for digital documents.

The physical processor 130 is responsible for executing the instructions necessary for the operation of the document 102. The physical processor 130 handles updates to the document 102 and ensures that the document's functionalities are carried out efficiently. The physical processor 130 works in conjunction with the API 103 to execute the document's operations and manage the interactions of the document 102 with users and external systems. In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the components described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The API 103 provides a standardized interface for interaction between the document 102 and external systems or users. The API 103 enables a range of functionalities, including controlled access, modification, and management of the content of the document. It serves as a conduit for interaction, allowing the document 102 to integrate seamlessly with other software systems and support enhanced functionalities like automated workflows and data synchronization. The integration of API 103 transforms the document 102 into an active, controllable entity that can interact with its environment in a secure and managed manner.

In the context of embodiments of this disclosure, the API embedded within the document serves as a pivotal component that transforms the document into a smart digital object. This API is not merely a set of protocols for building and interacting with software applications; it is an integral part of the document itself, enabling a wide array of functionalities that enhance the document's utility, security, and control.

The API 103 provides a standardized interface that enables the document to interact seamlessly with external systems, applications, and users. This integration enables the document to function as part of a larger digital ecosystem, where it can communicate and exchange data with other software systems, such as cloud services, enterprise applications, and third-party tools. Through the API 103, the document's owner or controller can remotely manage the document's access and usage. This includes monitoring who accesses the document, tracking changes, and enforcing security protocols. The API allows for real-time updates and modifications, ensuring that the document remains current and relevant, regardless of its location or the number of copies in existence.

The API can be equipped with robust security features, such as encryption and access control mechanisms, to protect the document from unauthorized access and tampering. It acts as a gatekeeper, ensuring that only authorized users can interact with the document. This level of security is essential for maintaining the integrity and confidentiality of the document's content. Additionally, the API enables dynamic content rendering, allowing the document to display the most current information and adapt its content based on user interactions or external data inputs. This capability is particularly useful for documents that require real-time updates, such as financial reports, legal documents, or collaborative projects.

By embedding the API within the document, embodiments of this disclosure support enhanced functionalities like automated workflows, data synchronization, and collaborative features. The API allows the document to function as an interactive and responsive entity that can interact with and respond to its environment, users, and other systems in a secure and managed manner. Furthermore, the API ensures that the document is device and platform agnostic, meaning it can be accessed and interacted with from various types of devices and operating systems without compatibility issues. This flexibility helps ensure that the document can be used effectively in diverse digital environments.

In some examples, the API serves as an immutable interface, providing a consistent and reliable framework for accessing and interacting with the document. This immutability ensures that the document's structure and access protocols remain stable over time, enhancing trust and reliability for users and applications interacting with the document. In summary, the API embedded within the document is a transformative component that elevates the document from a static file to a dynamic, interactive digital object. It provides the necessary infrastructure for secure, controlled, and flexible document management, addressing the challenges of traditional document handling and offering a comprehensive solution for modern digital environments. In other examples, some aspects of the API may be updated or revised over time without impacting accessibility of the document or the immutability of the content of the document.

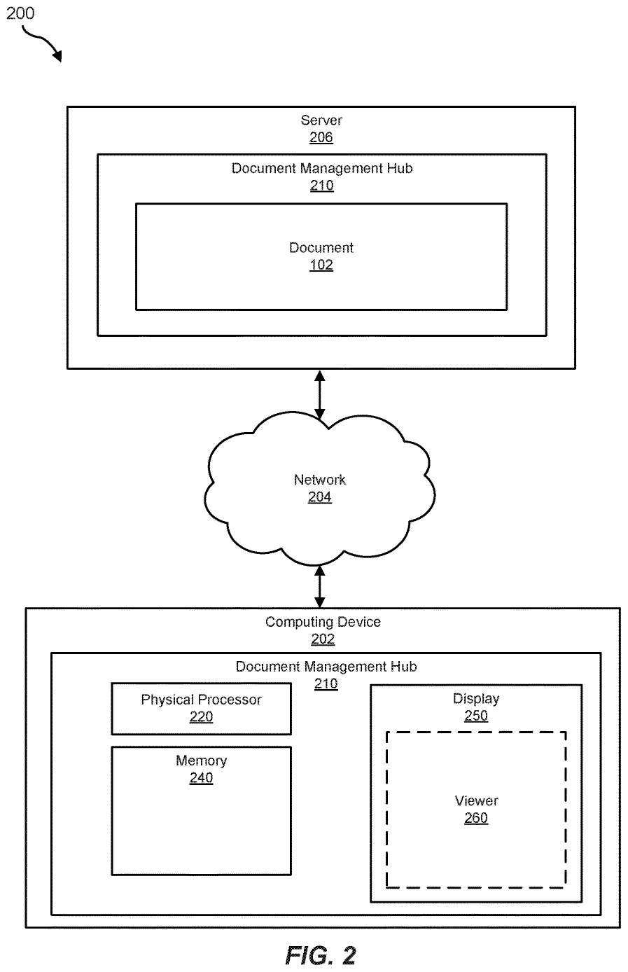

FIG. 2 can represent an architecture for managing electronic documents as smart digital objects. The system 200 comprises a computing device 202, a network 204, a server 206, a document 102, a document management hub 210 that can operate simultaneously in the server 206 and the computing device 202, a physical processor 220, a memory 240, and a viewer 260 that may be output on a display 250 communicatively coupled to the computing device 202.

The computing device 202 is a user-operated device that facilitates interaction with the system 200. The computing device 202 is operatively connected to the network 204 and includes the physical processor 220, the memory 240, and the viewer 260. The computing device 202 may be implemented as various types of devices, such as a mobile phone, tablet, desktop computing device, or laptop computing device. The physical processor 220 within the computing device 202 executes instructions to perform operations related to accessing and managing the document 102. The memory 240 stores data and instructions necessary for the operation of the computing device 202, including temporary and permanent storage of document-related information. The viewer 260 is responsible for rendering the content of the document 102 for presentation to the user, enabling functionalities such as real-time updates and collaborative editing.

The network 204 provides the communication pathway between the computing device 202 and the server 206. This pathway enables the transmission of requests, responses, and document content, while maintaining secure and efficient data exchange. The network 204 may be implemented using various communication technologies, including wired and wireless connections, and supports protocols such as TCP/IP and HTTP. The server 206 is a remote computing system that hosts the document 102. The server 206 is connected to the network 204 and interacts with the computing device 202 to process access requests and deliver the content of the document 102. The document 102 stored on the server 206 operates as a self-governing smart document capable of enforcing access permissions, tracking changes, and preserving the fidelity of the content within the document.

The document management hub 210 can include one or more machine readable instructions that are capable of being accessed and executed simultaneously by the processors of multiple devices, e.g., the computing device 202 and the server 206. While all of the machine readable instructions that comprise the document management hub 210 may be executable on multiple devices, not all devices may have access to all of the instructions that comprise the document management hub 210. The document management hub 210 comprises a set of instructions that control the generation and display of information. Further, the document management hub 210, operating in conjunction with an electronic document application as described herein, facilitates communication and sharing of information between a physical document and its electronic counterpart.

The physical processor 220 within the computing device 202 executes operations related to the system 200, including processing access requests, rendering document content, and managing user interactions. This component facilitates the computing device 202 in performing tasks independently and with optimized performance. The memory 240 provides storage capabilities for the computing device 202, including the temporary caching of document data and the storage of instructions required for the operation of the viewer 260. This configuration enables the computing device 202 to access and manage the document 102 in an efficient manner.

The viewer 260 serves as the interface enabling the user to engage with the document 102. This component presents the content of the document 102 for display, facilitating actions such as viewing, editing, and collaboration. The viewer 260 accommodates real-time updates and maintains alignment between the displayed content and the version stored on the Server 206.

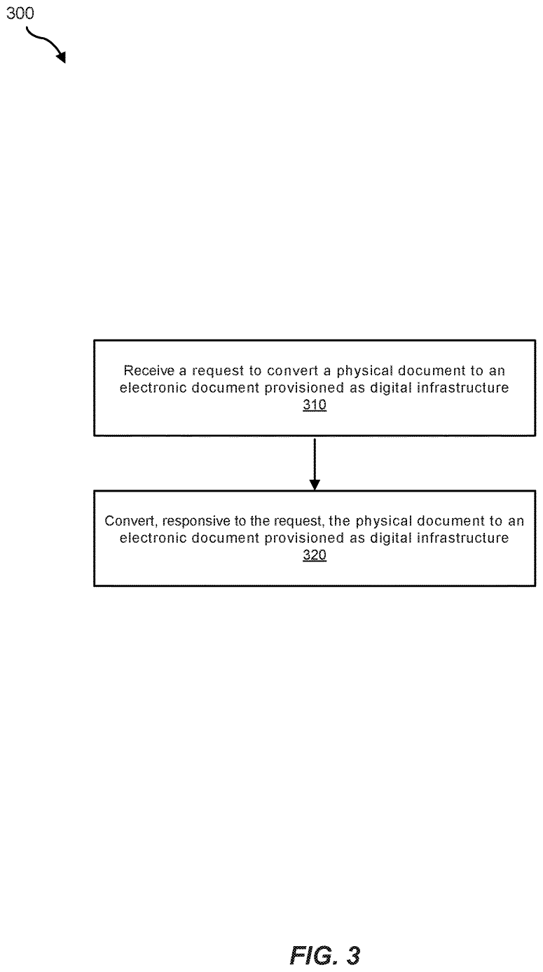

FIG. 3 illustrates a flowchart 300 of a method for converting a physical document into an electronic document provisioned as digital infrastructure and facilitating modification of an electronic document based on an interaction with the physical document. The electronic document will be referenced in this disclosure as “the electronic document 102” or “the document 102.” This flowchart begins with step 310, in which an application executing on a computing device receives a request to convert a physical document into an electronic document provisioned as digital infrastructure. Then, at step 320, the application converts, responsive to the request, the physical document into an electronic document provisioned as digital infrastructure.

At the outset, it is instructive to briefly revisit the concept of the document 102 as described herein. The document 102 acts as or is provisioned as digital infrastructure that integrates various interfaces and components to manage and update several capabilities and functionalities of the document. Specifically, the document 102 operates as a smart digital object capable of interacting with and incorporating various aspects of other electronic documents, various types of digital content (e.g., embedded videos, images, etc.), and aspects of a filing framework specific to an entity, e.g., government, company, etc. In some aspects, the document 102 operates as digital infrastructure within the document management hub 210 and accesses, interacts with, and performs various actions using code, data, and metadata included as part of the document 102 and code, data, and metadata included in other electronic documents.

The document 102 performs these actions either independent of or while operating in combination with the document management hub 210. Further, the document 102 provisioned as digital infrastructure can include three layers of data, namely code, data, and metadata. Each of the code, data, and metadata are simultaneously, sequentially, or in some other way accessible and executable by (1) the document 102 itself, (2) other documents provisioned as digital infrastructure and authorized to access the document 102, and (3) the document management hub 210. It is noted that any and all descriptions of code, data, and metadata that are provided in the paragraphs that follow this paragraph are applicable in addition to any definitions of code, data, and metadata that are provided earlier on in this disclosure.

Code, as described herein, refers to instructions written in a programming language (Java, C++, Python, etc.) that can be executed by, e.g., the server 206, the computing device 202, or another device that accesses the electronic document 102. When executed, the code facilitates (1) the performing of computations specific to the document 102, (2) access to the electronic document 102 by other devices, (3) revising of the electronic document 102, and (4) setting and updating of restrictions specific to the document 102. The code can be included as part of any of the set of instructions described above and shown in FIG. 1.

The data relates to the enhancing of the functionality, accessibility, and/or security of the document 102. This data can be stored directly within the document as embedded metadata, semantic tags, or encrypted content. This data and/or metadata associated with an electronic document may be stored in a single device or multiple devices. The data can refer to raw values or content that is processed by the code described above. Alternatively or additionally, data can be accessible by the document 102 through various sources, such as linked databases or cloud storage systems, etc. The document 102 can dynamically retrieve and update information in real-time from various sources, e.g., financial reports, investment prospectuses, stock prices or various user interactions. Moreover, as stated above, electronic documents provisioned as digital infrastructure can implement a number of access restrictions on themselves according to the preferences of the document owners. These restrictions can be updated approximately in real time as per the preferences of the document owners.

Additionally, data can be associated with the document 102 in other suitable ways, such as through audit trails, access logs, or related documents stored in a centralized system (e.g., the document management hub 210), providing a comprehensive view of the document's history and interactions. In some aspects, the APIs included as part of these documents provides a comprehensive view of a document interaction history to the owners. Indeed, in some examples, the term “electronic document” refers to any data, metadata, audit information, or intelligence that pertain to the electronic document. In other words, an electronic document may be made up of its data, metadata, intelligence, and/or other information. The data, metadata, intelligence, and/or other information of a document may be stored in any suitable manner (e.g., each of these items may be stored in a single database or device, distributed across multiple databases or devices, distributed across networked devices, etc.).

Data may be stored within or otherwise associated with an electronic document through execution of the electronic document on a computing device, a process that enables the document's function as a smart digital object. In some aspects, this process is not merely about saving data in a conventional sense but involves a sophisticated mechanism that ensures the document acts as a dynamic and interactive entity. As explained above, in some examples, the document is provisioned to maintain a single true copy, which facilitates ensuring consistency and integrity across all accessed versions. This single true copy can be stored in a secure environment, leveraging cloud-based infrastructure to facilitate accessibility and scalability.

Storing data within a document through execution of the document refers to the process where the document itself, as an active digital entity, manages and updates its own data content dynamically. This concept transforms the document from a static file into an interactive and intelligent object capable of executing operations to modify its content. In some examples this involves including executable code or an API as part of the document, which allows it to perform actions such as data retrieval, processing, and storage autonomously.

For example, a document can be programmed to fetch the latest data from a remote server or database whenever it is opened, updating its content with real-time information such as current stock prices or weather forecasts. Another example is a collaborative document that tracks changes made by different users, storing these modifications within the document itself to maintain a comprehensive version history. This capability is particularly useful in environments where documents need to reflect the most current data or where user interactions need to be logged and managed directly within the document. By executing these operations internally, the document can ensure data consistency and integrity.

Finally, metadata refers to the underlying information descriptive of the data. For example, the metadata can be characteristics, context, or structure of the data such that if the data corresponds to an image file, the metadata can be the dimensions, resolution, date information of the image file, and so forth. In another example, if the data were a video, the metadata may correspond to the duration of video, the video file size, etc. The code, data, and metadata are interoperable such that any or all of the code, data, or metadata of an electronic document 102 can be accessed and/or executed by the electronic document 102, the document management hub 210, or other documents provisioned as digital infrastructure.

Returning to FIG. 3, an application that receives a request to convert a physical document into an electronic document provisioned as digital infrastructure may execute on several different devices, e.g., laptops, servers, handheld devices, and so forth. For example, handheld devices may access this application via a software-based application store. The handheld devices can download and install a version of this application such that an instance of the application operates on a user's device while simultaneously operating on a number of additional devices. The physical document can be a paper document or any other form of a non-digital document upon which information can be written, stamped, or otherwise included, e.g., natural fiber-based materials, synthetic or alternative fiber materials, textile based or fabric-based materials.

Step 320 involves the application converting responsive to the request, via executing on a computer (e.g., a user's handheld device), the physical document into an electronic document provisioned as infrastructure. In other words, the application executing on the computer can, upon interacting with the physical document in some manner, convert the non-digital document (e.g., a paper document) into an electronic document as described herein. The interaction can involve the application utilizing a camera of a user's device to, e.g., obtain an image of the physical document, scan one or more aspects of the physical document such as a barcode, image, or other comparable identifier included on some portion of the physical document, and so forth.

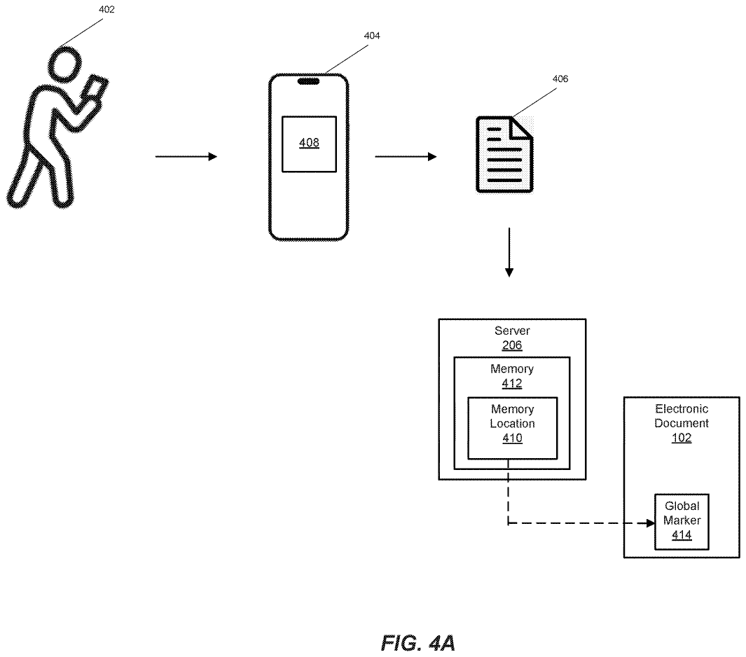

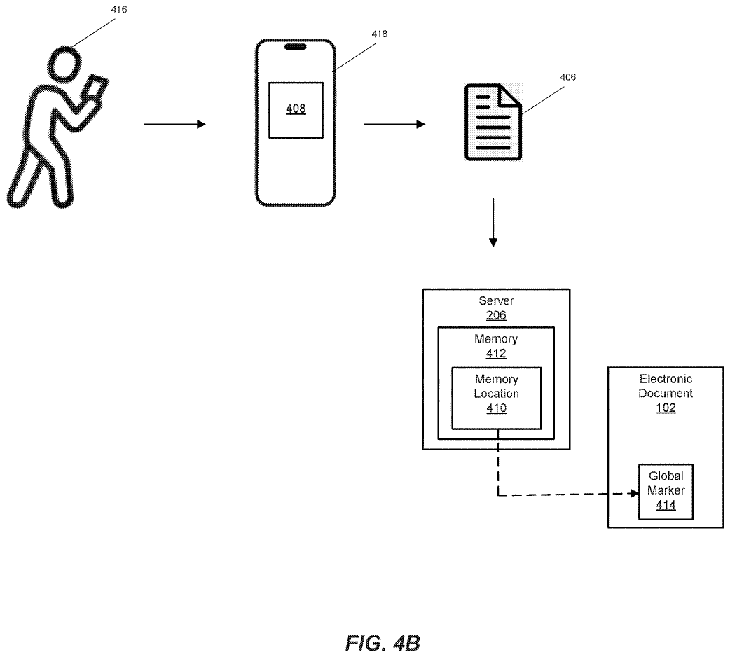

FIG. 4A illustrates results of an interaction between an application executing on a computing device and a physical document. For instance, an example user 402 may open an instance of the application executing on the computing device and utilize a handheld device (example smartphone 404) to take an image of a physical document 406. In response, an instance of the electronic document application 408 executing on the example smartphone 404 may convert, automatically and without user intervention, the physical document 406 into an electronic document provisioned as digital infrastructure (i.e. the electronic document 102). Specifically, the electronic document application 408 may generate, upon completion of the image capture of the physical document 406, a digital representation of the physical document 406 that includes (1) all of the subject matter of the physical document 406 and (2) an application programming interface (e.g., the API 103) as detailed above.

Next, upon completion of the conversion, the electronic document application 408 may store the electronic document 102 in a globally addressable location-in memory location 410 of memory 412 that is communicatively coupled to the server 206. The application 408 may also embed a global marker 414 as part of the electronic document 102. The global marker 414 can be a hexadecimal character based address (e.g., 019566cf-618e-7832-8332-9b7b14d16034) that associates the physical document 406 with its electronic counterpart in various ways. For example, the application 408, operating independently or by accessing and executing one or more instructions of the API 103, may identify and associate the example user 402 as a custodian or an individual having physical possession of the physical document 406 and the smartphone 404 as the device utilized for the conversion. The application 408 may store this information, automatically and without user intervention, in memory location 410 of the memory 412. In aspects, multiple instances of the electronic document application 408 executing on other handheld devices may provide notifications to users of these devices that the example user 402 is in physical possession of the physical document 406. The application instances may send such notifications to the email addresses of each of these users. Next, the global marker 414 can be a Uniform Resource Locator (URL), Universally Unique Identifier (UUID), a Globally Unique Identifier (GUID), or a set of alphanumeric characters based on some permutation or combination of one or more of these identifiers.

FIG. 4B illustrates the electronic document application 408 associating a new user as a custodian of the physical document 406. For instance, the example user 402 described above may be an owner and landlord of residential property and the physical document 406 may be a lease agreement. The example user 402, after the application 408 converts the physical document 406 into an electronic document, may hand over physical possession of the physical document 406 to an example user 416. The example user 416, a potential tenant interested in leasing the residential property, may access the electronic document application 408 via his example smartphone 418 and capture an image of the physical document 406. In response, the electronic document application 408 may identify and associate the example user 416 as the new custodian of the physical document 406 and the example smartphone 418 as the device utilized for obtaining an image of the physical document 406. The application 408 may store this information, automatically and without user intervention, in memory location 410 of the memory 412.

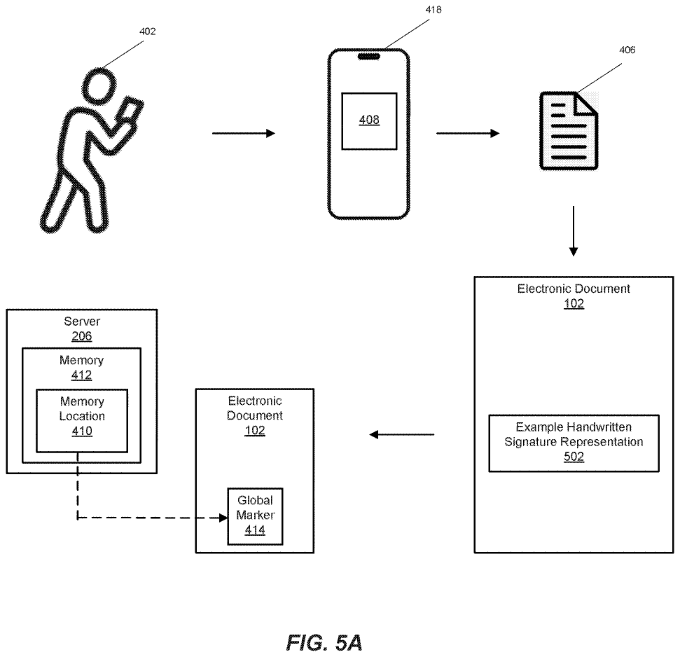

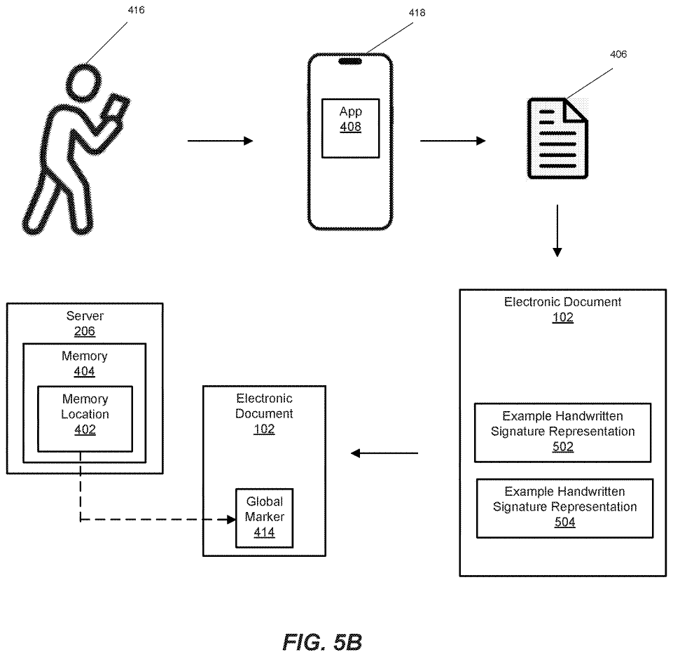

FIG. 5A illustrates the application 408 enabling content inclusion on the document 102 based on user interaction with the physical document 406. For example, the example user 402 may handwrite his signature on the physical document 406 and scan (or take an image of) the document 406 via the instance of the electronic document application 408 executing on the example smartphone 418. In response and approximately in real time (e.g., within a second or within fractions of a second), the application 408 may include a representation of the handwritten signature (example handwritten signature representation 502) as part of the electronic document 102. Further, data representing the example handwritten signature representation 502 may be stored in the memory location 410 of the memory 412.

FIG. 5B illustrates the application 408 enabling content inclusion on the document 102 based on another user interaction with the physical document 406. In this instance, after handwriting his signature on the physical document 406, the example user 402 may physically hand possession of the physical document 406 to the example user 416, who may then include his handwritten signature on the document 406. Thereafter, the user 416 may use the application 408 executing on the example smartphone 418 to obtain an image of the physical document 406. In response, the application 408 may include a representation of the handwritten signature of the example user 416 (example handwritten signature representation 504) as part of the electronic document 102. Further, the application 408 may store data representing the example handwritten signature representation 504 in the memory location 410 of the memory 412. In aspects, when the example user 416 obtains an image of the physical document 406 after signing it, the electronic document application 408 may output on a display of the example smartphone 418, automatically and without user intervention, the electronic document 102 as including both the example handwritten signature representation 502 and the example handwritten signature representation 504.

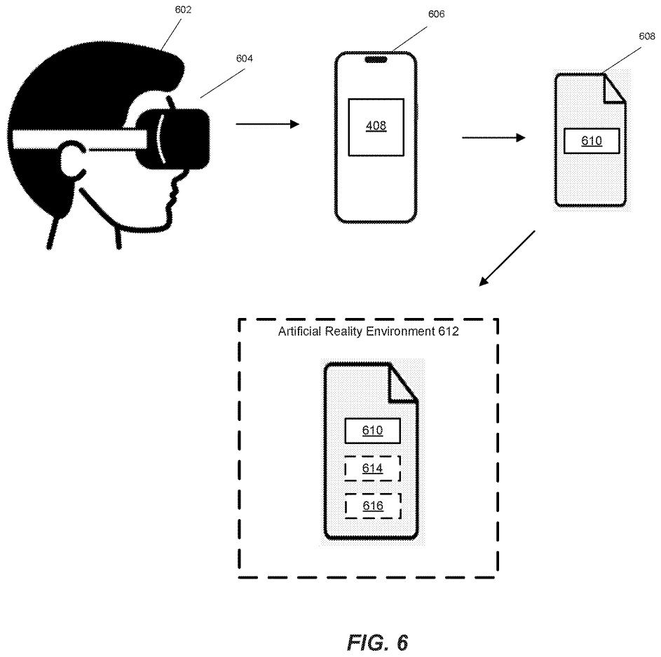

FIG. 6 illustrates a user interacting with an example physical document within a real-world environment and an artificial reality (AR) based environment. An example user 602 may be wearing an AR/VR based head mounted display 604 that is accessible by and operable with an instance of the application 408 executing on the user's example smartphone 606. In aspects, the example user 602 may obtain an image of an example physical document 608 that includes content in the form of, e.g., text 610. In response, the application 408 may output virtual content as part of an artificial reality environment 612 on the AR/VR based head mounted display 604.

For example, if the example physical document 608 were a flyer advertising an on-campus sporting event or social gathering, the text 610 may include a name of the event and the event's start time. The content presented in the artificial reality environment 612 may be details regarding a location 614 of the event and contact information 616 of one or more hosts of the event. In aspects, the application 408 may control the display of content in the artificial reality environment 612 based on various factors, e.g., based on characteristics of users associated with various instances of the electronic document application. For example, the hosts of the event may want to reveal the location 614 and the contact information 616 of the hosts only to university students.

As such, the application 408 may present university students with the largest amount of information in the artificial reality environment and designate these users as belonging to a particular tier, e.g., Tier 1. In contrast, the application 408 may present individuals with no connection to the university (e.g., outsiders) with a subset of the information presented to the university students, designating these individuals as belonging to a more restrictive tier than the students, e.g., Tier 2. In other words, if an outsider, wearing an AR based head mounted display, obtains an image of the physical document 608 via an instance of the application 408 executing on his smartphone, the application may only output text 610 and the location 614 of the event while omitting the contact information 616 of one or more of the hosts. The application 408 may determine the information for presentation in the artificial reality environment 612 based on the preferences of the owners of the example physical document 608, e.g., the hosts of the event in this instance.

In some examples, if a user accesses the application on a device (e.g., a printer, smartphone, etc.) and attempts to print the electronic document, the electronic document application may notify the user that (1) printing this particular document is a security risk and (2) the document's owner will be informed. As such, the electronic document application may generate an audit trail that lists actions taken relative to the document including, e.g., authorized or unauthorized attempts to print the document.

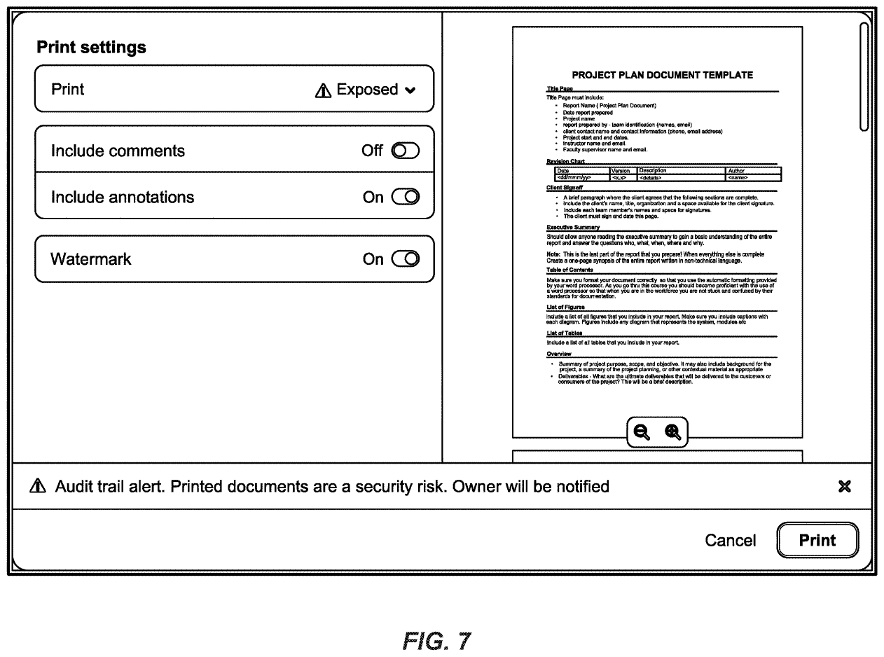

FIG. 7 depicts an example feature of the electronic document application 408 of the present disclosure. For example, if a user accesses the application 408 on his device (e.g., a printer, smartphone, etc.) and attempts to print the electronic document 102, the electronic document application 408 may notify the user that (1) printing this particular document is a security risk and (2) the document's owner will be informed. As such, the electronic document application 408 may generate an audit trail that lists actions taken relative to the document including, e.g., authorized or unauthorized attempts to print the document.

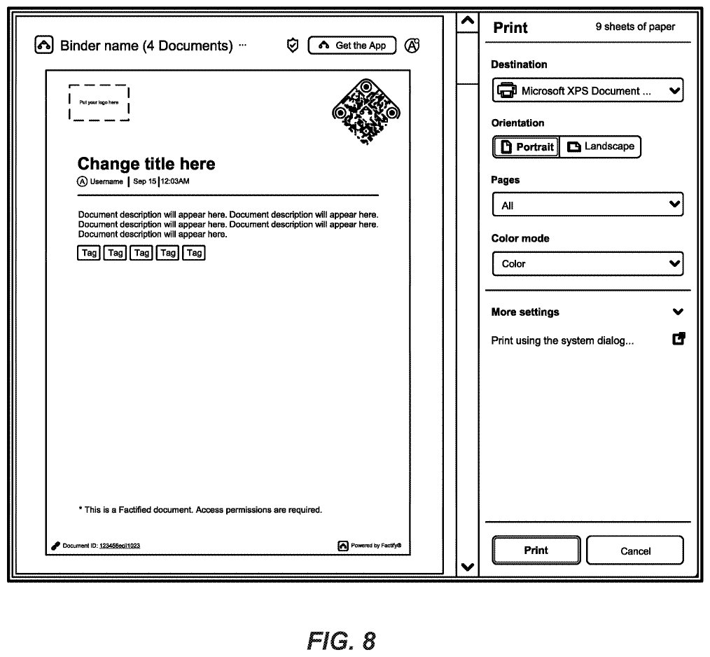

FIG. 8 illustrates the electronic document application 408 displaying results of a user attempting to print a document provisioned as digital infrastructure (e.g., the document 102). For example, the application 408 may include a barcode disposed on the top left portion and a statement on the bottom of the document that indicates that the document is provisioned as digital infrastructure, and as such, is governed by certain access permissions.

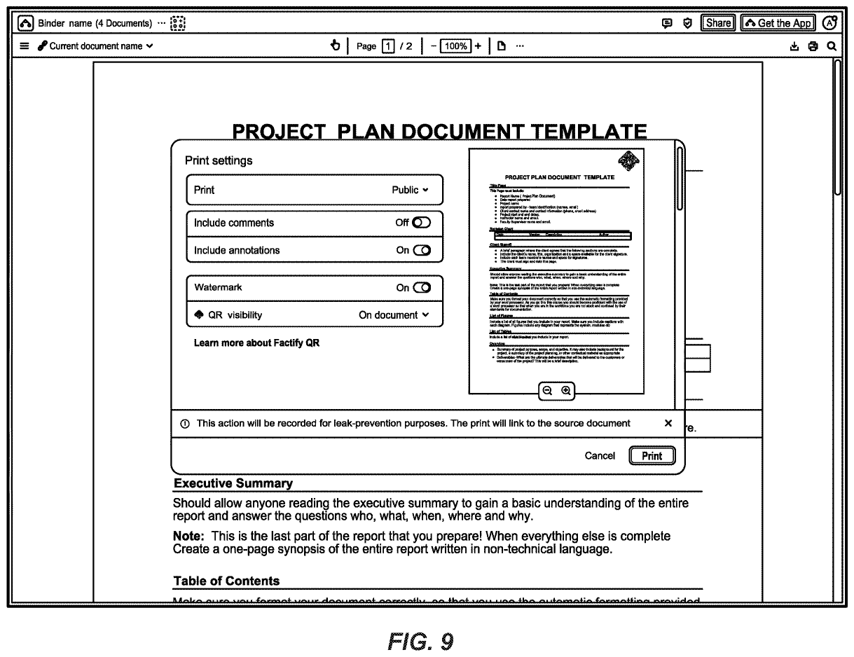

FIG. 9 illustrates a scenario in which the document application 408 automatically associates an electronic document provisioned as digital infrastructure, e.g., document 102, with its physical document counterpart upon the application 408 printing the document 102. In other words, as indicated by a message that may be generated and output by the application 408 on a user interface of a user's device, e.g., laptop, smartphone, or printer screen, the application 408 will link the printed version of the electronic document 102 with the document 102. The application 408, via such linking, facilitates control and modification of content of the electronic document via user interaction with the printed version thereof. For example, as explained above, if a user provides his handwritten signature on the printed document and then obtains an image of the printed document (or scans the printed document), the application 408 may, automatically and approximately in real time, include a representation of the handwritten signature directly on the electronic document 102.

Smart documents may revolutionize document management by actively controlling the printing process and ensuring the security, authenticity, and lifecycle of printed materials. Unlike traditional documents, which lose their connection to their digital counterparts upon printing, smart documents maintain their integrity and control, even after leaving the digital environment. Through embedded intelligence, cryptographic infrastructure, and dynamic interaction mechanisms, smart documents govern the printing process and the lifecycle of printed versions.

Smart documents may regulate whether a document can be printed by evaluating the context, user permissions, and security implications. The smart document assesses the identity of the user attempting to print, verifies their access rights, and determines the sensitivity of the document's content. If the user lacks the necessary permissions or the document contains confidential information, the smart document denies the print request outright, preventing unauthorized individuals from printing sensitive materials and safeguarding the integrity of the information.

When a print request is approved, the smart document dynamically generates a printed version that adheres to predefined rules and security protocols. The smart document embeds watermarks, barcodes, and other identifiers into the printed version, linking it back to its digital counterpart. These identifiers verify the authenticity of the printed document, track its lifecycle, and prevent unauthorized duplication. The smart document includes classification-level watermarks and barcodes encoding metadata about the document's origin, owner, and access history, ensuring the printed document remains traceable and secure outside the digital environment.

Smart documents may enforce restrictions on the printed version to maintain control over its distribution. The smart document limits the number of copies that can be printed and specifies the devices authorized to perform the printing. The smart document embeds expiration mechanisms within the printed version, rendering the document invalid after a certain period or under specific conditions. For example, the smart document displays a visible expiration date on a printed contract, ensuring the document becomes unusable after the specified timeframe. These restrictions align the printed document with the security and lifecycle requirements of its digital counterpart.

Smart documents may adapt the printed version to the context of the print request. In a public setting, the smart document redacts sensitive sections to prevent unauthorized access. For internal use, the smart document includes additional annotations or metadata to facilitate collaboration. The smart document tailors the printed version to the specific context, ensuring the printed document serves its intended purpose while maintaining the security and integrity of the information.

Smart documents actively monitor and audit the printing process. The smart document logs every print request in its audit trail, recording details such as the user's identity, the time and location of the print request, and the device used for printing. The smart document provides a comprehensive record of all printing activities, enabling organizations to track the lifecycle of printed documents and identify potential security breaches. If a sensitive document is found in an unauthorized location, the smart document reveals who printed the document and when, facilitating investigations and corrective actions. This transparency ensures accountability and reduces the risk of misuse.

Smart documents intervene to prevent unauthorized actions during the printing process. If a user attempts to print a document on an untrusted device, the smart document blocks the request and notifies the document's owner. If a user attempts to print a document in a format that violates security protocols, such as printing without watermarks or identifiers, the smart document modifies the print output to enforce compliance. These interventions ensure the printed version adheres to the organization's security policies and standards, eliminating the risk of data leakage or tampering.

Smart documents may maintain a connection to their digital counterparts throughout the lifecycle of the printed version. The smart document embeds identifiers and metadata into the printed version, enabling it to track the lifecycle of the printed document as it moves through physical environments. For example, the smart document includes a QR code on the printed version that, when scanned, reveals its digital audit trail and verifies its authenticity. The smart document ensures the printed document remains a trusted and verifiable representation of its digital counterpart, eliminating the risk of forgery or misuse.

Smart documents may facilitate interactions between the printed version and the digital environment. When a user annotates the printed document and scans it back into the system, the smart document integrates the annotations into its digital version. The smart document bridges the gap between physical and digital environments, ensuring the printed document remains an active participant in the document's lifecycle. By enabling bidirectional interaction, the smart document enhances collaboration and streamlines workflows.

Smart documents may possess the ability to perform deduplication after scanning or printing, ensuring that the integrity and lifecycle of the document remain intact while eliminating redundancies. This capability is rooted in the embedded intelligence of the smart document, which actively monitors and manages its interactions with physical and digital environments. When a smart document is scanned or printed, it does not merely replicate its content; it actively evaluates the context of the interaction, identifies potential duplicates, and takes decisive actions to maintain a single authoritative version of the document.

Upon scanning, the smart document analyzes the incoming data to determine whether it corresponds to an existing version of the document. This process involves comparing the scanned content with the document's immutable metadata, audit trail, and cryptographic identifiers. The smart document identifies whether the scanned version represents a new interaction, an update, or a duplicate of an existing version. If the scanned content matches the original document, the smart document prevents the creation of redundant copies by linking the scanned version directly to the authoritative version stored within its digital infrastructure. This ensures that the scanned version does not fragment the document's lifecycle or create inconsistencies across different systems.

The smart document can also perform deduplication during the printing process. When a user initiates a print request, the smart document evaluates the context of the request, including the user's identity, access permissions, and the intended purpose of the printed version. The smart document embeds unique identifiers, such as watermarks, barcodes, or cryptographic signatures, into the printed version to establish a direct connection between the physical copy and its digital counterpart. These identifiers allow the smart document to track the lifecycle of the printed version and prevent the proliferation of unauthorized or redundant copies. If a user attempts to scan the printed version back into the system, the smart document recognizes the embedded identifiers and links the scanned copy to the original document, ensuring that no duplicate versions are created.

The deduplication process extends beyond simple content matching. The smart document actively monitors its audit trail and metadata to identify interactions that may result in duplication. For example, if multiple users attempt to scan or print the same document, the smart document evaluates the context of each interaction to determine whether a new version is necessary. In cases where the scanned or printed version does not introduce new content or interactions, the smart document consolidates the data into the existing authoritative version, maintaining a single source of truth. This prevents the fragmentation of the document's lifecycle and ensures that all interactions are accurately recorded within the audit trail.

Deduplication also plays a role in collaborative workflows. When multiple users interact with the smart document, the embedded intelligence ensures that their contributions are integrated into the authoritative version without creating redundant copies. For instance, if a user annotates a printed version of the document and scans it back into the system, the smart document incorporates the annotations into its digital counterpart while preserving the integrity of the original content. This process eliminates the need for manual reconciliation of multiple versions and streamlines collaboration by maintaining a unified document lifecycle.

The smart document's ability to perform deduplication is further enhanced by its dynamic rendering capabilities. When a user accesses the document, the smart document adapts its content and layout based on the user's role, device, and context. This ensures that users interact with the most relevant and up-to-date version of the document, reducing the likelihood of duplication caused by outdated or fragmented versions. For example, if a user prints a document for review, the smart document embeds contextual information into the printed version, such as timestamps, user interactions, or workflow status. This information allows the smart document to identify the printed version as part of the existing lifecycle, preventing the creation of redundant copies when the document is scanned back into the system.

The deduplication process also addresses the challenges of managing physical and digital versions of the document simultaneously. Traditional document management systems often struggle to reconcile physical copies with their digital counterparts, leading to inconsistencies and duplication. Smart documents overcome this limitation by maintaining a persistent connection between the physical and digital versions. When a user scans a printed document, the smart document recognizes the embedded identifiers and updates its audit trail to reflect the interaction. This ensures that the scanned version is seamlessly integrated into the document's lifecycle without creating duplicates or disrupting the integrity of the original content.

By actively managing deduplication, smart documents enhance the efficiency and reliability of document workflows. They eliminate the need for manual intervention to reconcile multiple versions, reduce storage requirements by maintaining a single authoritative copy, and ensure that all interactions are accurately recorded within the audit trail. This capability is particularly valuable in industries where document integrity and compliance are critical, such as legal, healthcare, and finance.

For example, in a legal setting, the smart document prevents the proliferation of redundant copies of contracts or agreements, ensuring that all parties interact with the same authoritative version. In healthcare, the smart document consolidates patient records into a single source of truth, reducing the risk of errors caused by fragmented data. In finance, the smart document streamlines reporting by maintaining a unified version of financial statements, eliminating redundancies and ensuring accuracy.

The deduplication process also contributes to the security and trustworthiness of smart documents. By preventing the creation of unauthorized or redundant copies, the smart document reduces the risk of data leakage or tampering. The embedded identifiers and cryptographic signatures ensure that all versions of the document can be traced back to their original source, providing a reliable mechanism for verifying authenticity. This level of control and transparency enhances user confidence in the document's integrity and reduces the likelihood of disputes or compliance issues.

Smart documents are designed to seamlessly bridge the gap between the digital and physical realms, ensuring that their lifecycle remains intact and traceable even after transitioning into printed form. Each printed version of a smart document is equipped with a unique identifier, which serves as a persistent link between the physical copy and its digital counterpart. This identifier is embedded within the printed document in a manner that is both unobtrusive and integral to its functionality, enabling the document to maintain its connection to the broader digital ecosystem.

The unique identifier is generated during the printing process and is encoded using advanced cryptographic techniques to ensure its authenticity and security. This identifier is embedded directly into the printed document as a barcode, QR code, watermark, or other machine-readable format. It is designed to be immutable, meaning it cannot be altered or tampered with once the document is printed. The identifier encapsulates essential metadata about the document, including its origin, version history, and access permissions, allowing the printed copy to retain the same level of intelligence and traceability as its digital counterpart.

When a printed smart document is scanned or otherwise accessed, the embedded identifier serves as the key to unlocking its digital audit trail. The identifier is used to query the document's digital infrastructure, retrieving information about its lifecycle, interactions, and provenance. This process ensures that the printed document remains an active participant in the document's lifecycle, rather than becoming a static and disconnected artifact. The identifier allows the document to autonomously verify its authenticity, confirm its ownership, and provide a comprehensive record of its interactions, even in physical form.

The tracking capabilities of smart documents extend beyond simple identification. The unique identifier enables the document to monitor its distribution and usage across various environments. For example, when a printed document is shared or transferred between parties, the identifier allows the document to record the details of these interactions, including the identities of the individuals involved, the time and location of the transfer, and any modifications made to the document. This information is stored within the document's digital infrastructure, ensuring that its audit trail remains complete and accurate.

Smart documents also leverage their unique identifiers to enforce access permissions and security protocols for printed copies. The identifier allows the document to verify whether the individual attempting to access or interact with the printed version has the necessary permissions. If the access request is unauthorized, the document can restrict access to sensitive information or provide a limited view of its content. This capability ensures that the printed document maintains the same level of security and control as its digital counterpart, preventing unauthorized duplication or misuse.

The unique identifier embedded within printed smart documents also facilitates efficient collaboration and workflow management. When multiple parties interact with the printed version of a document, the identifier allows the document to track and synchronize these interactions with its digital counterpart. For instance, if a user annotates the printed document and scans it back into the system, the identifier ensures that these annotations are integrated into the authoritative digital version. This process eliminates the need for manual reconciliation of changes and ensures that all interactions are accurately recorded within the document's audit trail.

Smart documents utilize their unique identifiers to support advanced analytics and insights. By tracking the lifecycle and interactions of printed copies, the document can provide valuable data about its usage and distribution. This information can be used to optimize workflows, identify patterns in document interactions, and enhance decision-making processes. For example, the document can analyze its distribution network to identify bottlenecks or inefficiencies, enabling organizations to streamline their operations and improve productivity.

The integration of unique identifiers within printed smart documents also enhances their interoperability with external systems and platforms. The identifier allows the document to seamlessly integrate with databases, enterprise applications, and third-party tools, enabling automated workflows and data synchronization. For instance, the document can use its identifier to update related systems with information about its interactions, ensuring that all platforms remain aligned and up-to-date.

Smart documents maintain their connection to their digital counterparts throughout the lifecycle of the printed version, ensuring that the physical copy remains a trusted and verifiable representation of the original document. The unique identifier embedded within the printed document serves as a reliable mechanism for verifying its authenticity and provenance, eliminating the risk of forgery or misuse. This capability is particularly valuable in industries where document integrity and compliance are paramount, such as legal, healthcare, and finance.

The tracking capabilities enabled by the unique identifier also contribute to the security and trustworthiness of smart documents. By maintaining a persistent link between the printed and digital versions, the document ensures that all interactions are accurately recorded and traceable. This level of control and transparency enhances user confidence in the document's integrity and reduces the likelihood of disputes or compliance issues.

A smart document operates as an intelligent entity capable of interacting with its environment and responding to external stimuli. When a scanner identifies a document via a code embedded on the document, the smart document initiates a sequence of actions that leverage its embedded intelligence and connectivity. The code, which may be a barcode, QR code, or other machine-readable identifier, serves as a gateway for the scanner to establish communication with the smart document. This interaction is not limited to simple identification; it encompasses a dynamic exchange of information that transforms the document from a static artifact into an active participant in its lifecycle.

Upon being scanned, the smart document recognizes the code as a unique identifier that links it to its digital infrastructure. This identifier encapsulates metadata about the document, including its origin, version history, and access permissions. The scanner transmits the code to the smart document's embedded application programming interface (API), which processes the incoming request and retrieves the corresponding data. The smart document uses this data to verify its authenticity, confirm its ownership, and provide a comprehensive record of its interactions. This verification process ensures that the document remains secure and trustworthy, even as it transitions between physical and digital environments.

The smart document responds to the scanner's request by presenting its content and metadata in a structured format. This presentation is tailored to the scanner's capabilities and the context of the interaction. For example, the smart document may render its content as a digital file that can be displayed on a connected device or as a set of instructions for further processing. The document's embedded intelligence enables it to adapt its response based on the scanner's specifications, ensuring seamless integration with external systems and workflows. The interaction between the scanner and the smart document extends beyond simple data retrieval. The smart document actively monitors the scanning process and records details about the interaction, such as the time and location of the scan, the identity of the scanner, and the nature of the request. This information is stored within the document's audit trail, creating a transparent and traceable record of its lifecycle. The audit trail serves as a definitive source of truth, providing stakeholders with insights into the document's history and interactions.

The smart document leverages its embedded intelligence to analyze the scanning event and determine its implications for the document's lifecycle. For instance, the document may update its metadata to reflect the scan as a new interaction or trigger automated workflows based on the scanning event. These workflows can include notifying authorized users about the scan, updating related systems with the scanned data, or initiating actions such as approvals or transfers. The smart document's ability to autonomously manage these processes enhances its utility and efficiency, reducing the need for manual intervention.

The code embedded on the document plays a pivotal role in facilitating these interactions. It acts as a persistent link between the physical and digital versions of the document, ensuring that the document remains connected to its digital infrastructure throughout its lifecycle. The code encapsulates essential information about the document, enabling the scanner to access its content and metadata without compromising its security or integrity. The smart document uses cryptographic techniques to protect the code from tampering, ensuring that it remains a reliable mechanism for identification and interaction.

The smart document's response to the scanner is not limited to presenting its content and metadata. It also provides contextual information that enhances the scanner's understanding of the document's purpose and relevance. For example, the document may include annotations, comments, or instructions that guide the scanner in processing the document. These contextual elements are dynamically generated based on the document's metadata and the scanner's capabilities, ensuring that the interaction is both meaningful and efficient.

The interaction between the scanner and the smart document exemplifies the document's ability to bridge the gap between physical and digital environments. By leveraging its embedded intelligence and connectivity, the smart document transforms the scanning process into a dynamic exchange of information that enhances its lifecycle and utility. The document's ability to respond to the scanner's request, verify its authenticity, and manage its interactions underscores its role as an active participant in modern workflows.

The smart document's embedded intelligence enables it to integrate seamlessly with external systems and platforms. When the scanner identifies the document via its code, the document uses its API to communicate with these systems and synchronize its data. This integration ensures that the document remains aligned with its digital infrastructure, enabling automated workflows and data synchronization. The document's ability to interact with external systems enhances its interoperability and utility, making it a valuable asset in diverse environments.

The smart document's interaction with the scanner also highlights its role in ensuring security and compliance. By verifying its authenticity and recording the scanning event in its audit trail, the document provides a reliable mechanism for tracking its lifecycle and interactions. This level of transparency and traceability reduces the risk of misuse or tampering, ensuring that the document remains secure and trustworthy throughout its lifecycle.

A smart document operates as an autonomous entity capable of identifying, extracting, and processing information from a filled form to create a new document while simultaneously harvesting signatures associated with the form. This process begins when the smart document interacts with a filled form, whether in physical or electronic format. The smart document actively scans the form, identifying the fields that have been completed and distinguishing between handwritten entries, typed text, and other forms of input. Using its embedded intelligence, the smart document analyzes the structure of the form, recognizing predefined fields, contextual relationships between the fields, and the content provided by the user.

The smart document extracts the data from the completed fields with precision, ensuring that the information is accurately captured and categorized. It processes the extracted data by mapping it to corresponding fields in a new document, which it generates autonomously. This new document reflects the content of the filled form, preserving the integrity of the original data while presenting it in a structured and machine-readable format. The smart document ensures that the new document is formatted appropriately, adhering to predefined templates or user-defined specifications. It incorporates metadata that describes the origin of the data, the time of extraction, and the identity of the user who completed the form.

In addition to extracting data, the smart document actively harvests signatures associated with the filled form. When a signature is present, the smart document identifies it as a distinct element within the form. It analyzes the signature to determine its type, whether it is handwritten, electronic, or biometric. For handwritten signatures, the smart document captures a digital representation of the signature, preserving its visual characteristics and associating it with the corresponding user. For electronic signatures, the smart document retrieves the cryptographic data that validates the signature, ensuring its authenticity and linking it to the signer's identity. For biometric signatures, the smart document processes the biometric data, such as facial recognition or fingerprint scans, and integrates it into the new document as a secure and verifiable element.

The smart document autonomously verifies the authenticity of the harvested signatures by cross-referencing them with identity data stored within its digital infrastructure. It accesses the signer's public key or other identity credentials to confirm that the signature is valid and has not been tampered with. This verification process ensures that the new document accurately reflects the actions of the signers and maintains the integrity of the original form. The smart document embeds the verified signatures into the new document, associating them with the relevant fields or sections of the document. It also records the timeline of the signing process, creating an audit trail that documents when and how each signature was provided. Throughout this process, the smart document operates as a self-governing entity, managing the lifecycle of the filled form and the new document it creates. It tracks every interaction with the form, including the extraction of data, the harvesting of signatures, and the generation of the new document. These interactions are recorded in the smart document's audit trail, which serves as a comprehensive record of the document's history. The audit trail includes metadata about the form, the extracted data, the harvested signatures, and the identities of the users involved. This metadata is cryptographically secured, ensuring that the audit trail remains immutable and trustworthy.

The smart document also facilitates the distribution and sharing of the new document. Once the document is created and signatures are harvested, the smart document determines the appropriate recipients based on predefined rules or user preferences. It autonomously shares the document with authorized parties, ensuring that access permissions are enforced and sensitive information is protected. The smart document monitors the distribution process, recording details about who accessed the document, when it was accessed, and the nature of the interaction. This monitoring ensures that the document remains secure and that its lifecycle is fully traceable.

By autonomously identifying, extracting, and processing information from filled forms, the smart document transforms the way forms are managed and utilized. It eliminates the need for manual data entry, reduces the risk of errors, and ensures that the information captured in the form is accurately reflected in the new document. The smart document's ability to harvest and verify signatures further enhances the reliability and security of the document, providing a robust framework for managing signed forms in digital environments. Through its embedded intelligence and connectivity, the smart document seamlessly integrates the filled form into its lifecycle, creating a new document that is secure, verifiable, and ready for use.

A smart document is designed to ensure the integrity, authenticity, and traceability of its content and associated audit trail through the use of immutability, a global marker, and embedded intelligence. This innovative structure addresses longstanding challenges in document management, auditing, and compliance.

### Immutable Content

The content of a smart document is immutable, meaning it cannot be altered once finalized. This immutability is achieved through cryptographic techniques, such as hashing and digital signatures. When the document is created, its content is hashed to produce a unique cryptographic fingerprint. This hash is stored alongside the document and serves as a reference for verifying the integrity of the content. Any attempt to modify the content would result in a mismatch between the original hash and the hash of the altered content, immediately signaling tampering. Additionally, the document may be digitally signed using the creator's private key, ensuring that the content is not only unchangeable but also verifiable as originating from the authorized source.

### Immutable Audit Trail

The audit trail of a smart document is equally immutable. The audit trail records every interaction with the document, including access, modifications, approvals, signatures, and other events. Each event in the audit trail is cryptographically secured and timestamped, ensuring that the sequence of events is preserved and cannot be altered retroactively. For example, when a user accesses the document, the system generates a cryptographic record of the access event, including the user's identity, the time of access, and the nature of the interaction. These records are stored in a manner that prevents deletion or modification, ensuring the audit trail remains a reliable source of truth. The audit trail is also linked to the document's content, creating a unified record of both the document and its history.

### Immutable Connection to a Permanent Global Marker

Both the immutable content and the immutable audit trail are connected to an immutable global marker, which serves as the unique and unchanging identifier for the document. The global marker can be implemented as a universally unique identifier (UUID) or a cryptographic address, such as a hash-based identifier. This marker is permanent and does not change throughout the lifecycle of the document, regardless of how or where the document is accessed. The global marker ensures that the document can always be referenced and retrieved in its original form, providing a single source of truth.

The connection between the content, audit trail, and global marker established through cryptographic linking. The global marker is embedded in the document's metadata, and the metadata itself is cryptographically secured to prevent tampering. The audit trail is also linked to the global marker, ensuring that every recorded event is associated with the correct document. This triad—immutable content, immutable audit trail, and an immutable association between the global marker and the content and audit trail—creates a robust framework that will revolutionize document management and control.

The immutability of the content, the audit trail, the global marker and of the link between the marker and the data (i.e., the content, the audit trail, and any other metadata) and the global marker, can have one or more of a variety of characteristics:

Unchangeable: Immutable refers to something that cannot be altered, modified, or edited once it has been created or finalized.

Permanent: Immutable signifies a state of permanence, where the object or data remains fixed and consistent over time.

Irreversible: Immutable describes a condition where changes are impossible, and any attempt to alter the object or data is invalid or rejected.

Fixed: Immutable means that the structure, content, or state of an object is locked and cannot be adjusted or updated.

Tamper-Proof: Immutable implies that the object or data is resistant to tampering, ensuring its integrity and authenticity.

Finalized: Immutable refers to an object or data that has reached its final form and cannot be reverted or reshaped.

Unmodifiable: Immutable describes a characteristic where the object or data is impervious to modification, whether intentional or accidental.

Consistent: Immutable ensures that the object or data remains consistent and reliable, unaffected by external influences or changes.

Secure: Immutable denotes a state of security where the object or data is safeguarded against unauthorized alterations or corruption.

Indelible: Immutable refers to something that is permanent and cannot be erased, overwritten, or replaced.

### Benefits of the Immutable Structure

Integrity: The immutability of the content ensures that the document remains unchanged and trustworthy throughout its lifecycle.

Traceability: The immutable audit trail provides a complete and verifiable history of all interactions with the document.

Authenticity: The permanent global marker guarantees that the document can always be uniquely identified and retrieved, eliminating ambiguity.

Compliance: This structure simplifies regulatory compliance by providing a reliable and tamper-proof record of the document and its history.

Interoperability: The global marker enables seamless integration with external systems, ensuring that the document can be referenced and verified across different platforms.

In summary, a smart document achieves immutability of its content and audit trail while ensuring both are immutably connected to a permanent global marker. This design provides a transformative solution for document management, offering unparalleled integrity, authenticity, and traceability.

While in some examples of smart documents the content, the audit trail, and the link to the global marker are all immutable, in other examples one of or two of these three items may be immutable. In some examples, the entirety of the content and the audit trail are immutable, and in others only a portion of the content and/or the audit trail are immutable. Furthermore, a smart document may have content and an audit trail that are immutable while having other metadata that is changeable (e.g., comments, access rights, etc.) In addition to the foundational features of immutability, smart documents possess embedded intelligence that enables them to actively interact with their environment, respond to requests, and perform actions autonomously. This intelligence transforms the document from a static repository of information into a dynamic, interactive entity capable of understanding and adapting to its context. Embedded intelligence in smart documents is achieved through the integration of executable code, metadata, and machine-readable content, all of which work together to create a responsive and self-aware system.

### Features of Embedded Intelligence

Self-Determination and Responsiveness: Smart documents are equipped with the ability to process requests and respond dynamically. For example, when a user or system queries a document, the embedded intelligence allows the document to access its metadata, audit trail, and content to determine the appropriate response. This responsiveness is not limited to simple data retrieval; the document can also perform complex operations, such as verifying its authenticity, providing access logs, or extracting specific information from its content.

Contextual Awareness: Smart documents can understand and adapt to their context. This includes recognizing the identity of the user accessing the document, the device being used, the location of the access, and the stage of the document's lifecycle. For instance, a contract document may display different user interfaces depending on whether it is being accessed by the creator, a signatory, or a reviewer. Similarly, the document can adapt its behavior based on whether it is being accessed on a mobile device, desktop, or tablet.

Negotiation of Communication Protocols: Smart documents are capable of negotiating the manner in which they communicate with external systems. They can respond to requests using various protocols, such as RESTful APIs, gRPC, or even machine-specific languages like MCP (Machine Communication Protocol). This flexibility ensures that the document can seamlessly integrate with diverse systems and applications, making it highly interoperable.

Dynamic User Experience: The embedded intelligence enables smart documents to create personalized user experiences. For example, the document can present different panels, workflows, or visualizations depending on the user's role, the document's lifecycle stage, or the specific task being performed. This dynamic adaptability enhances usability and ensures that the document serves the needs of each stakeholder effectively.

Machine Learning and Predictive Capabilities: Smart documents can leverage machine learning algorithms to analyze their audit trail, content, and metadata to predict user needs or suggest actions. For instance, a smart document could identify patterns in user interactions and recommend next steps, such as suggesting additional documents that may be relevant to the current task or flagging anomalies in the audit trail for review.

### How Intelligence Is Embedded

The intelligence of smart documents is embedded through the integration of one or more components:

Executable Code: At the core of a smart document's intelligence is its embedded executable code. This code acts as the “brain” of the document, enabling it to process requests, perform actions, and interact with external systems. The code is designed to be lightweight and modular, allowing it to execute specific tasks efficiently without compromising the document's performance.

Metadata: Metadata provides the document with contextual information about itself, such as its creation date, owner, version history, and access permissions. This metadata is stored in a machine-readable format and is cryptographically secured to ensure its integrity. The document's intelligence uses this metadata to make decisions and respond to queries.

Machine-Readable Content: Unlike traditional documents, which are primarily human-readable, smart documents store their content in a machine-readable format. This allows the embedded intelligence to analyze the content, extract specific information, and perform operations based on the content's structure and meaning.

APIs for Interaction: Smart documents expose APIs (Application Programming Interfaces) that allow external systems to interact with them. These APIs enable the document to receive requests, process them, and return responses in a structured format, such as JSON or XML. The APIs also facilitate integration with other applications and systems, making the document highly interoperable.

Cryptographic Infrastructure: The intelligence of smart documents is underpinned by cryptographic infrastructure, which ensures the security and authenticity of the document's interactions. For example, digital signatures and hash-based identifiers are used to verify the integrity of the document and its audit trail, while encryption protects sensitive data.

Machine Learning Models: Machine learning models can be embedded within the document or accessed through external systems to enhance its intelligence. These models enable the document to analyze patterns, predict outcomes, and adapt its behavior based on historical data and real-time inputs.

### Examples of Embedded Intelligence in Action

Audit Trail Analysis: A smart document can analyze its audit trail to identify unusual patterns, such as repeated failed access attempts, and alert the owner to potential security risks.

Dynamic Rendering: When accessed on a mobile device, a smart document can automatically adjust its layout to optimize readability and usability, while providing additional features like touch-based navigation.

Workflow Management: A smart document associated with a workflow can track its progress and notify stakeholders of pending actions, such as signatures or approvals.

Content Extraction: A smart document can respond to a query by extracting specific information from its content, such as the total amount in an invoice or the number of items listed in a receipt.

Protocol Negotiation: A smart document can negotiate the format of its responses based on the preferences of the requesting system, such as providing data in JSON for web applications or XML for enterprise systems.

In summary, the embedded intelligence of smart documents is achieved through the integration of executable code, metadata, machine-readable content, APIs, cryptographic infrastructure, and machine learning models. This intelligence enables the document to interact dynamically with its environment, adapt to its context, and provide personalized experiences, making it a transformative innovation in document management.

The combination of immutability and embedded intelligence in smart documents creates a transformative paradigm for document management, offering unparalleled integrity, authenticity, traceability, and adaptability. Together, these features address longstanding challenges in document security, compliance, and usability, while enabling dynamic interactions and personalized experiences.

### The Synergy of Immutability and Embedded Intelligence

The combination of immutability and embedded intelligence creates a powerful synergy that revolutionizes document management. Immutability provides the foundation of trust, ensuring that the document's content and history are secure, authentic, and tamper-proof. Embedded intelligence builds on this foundation, enabling the document to interact dynamically with its environment, adapt to its context, and provide personalized experiences.

Enhanced Integrity and Authenticity: Immutability ensures that the document's content and audit trail remain unchanged, while embedded intelligence enables the document to verify its authenticity and respond to queries about its provenance. Together, these features create a system where trust is inherent and verifiable.

Dynamic Traceability: The immutable audit trail provides a complete history of interactions with the document, while embedded intelligence allows the document to analyze and interpret this history. This dynamic traceability enables stakeholders to understand not only what happened to the document but also why and how.

Personalized Compliance: Immutability simplifies regulatory compliance by providing a reliable and tamper-proof record of the document and its history. Embedded intelligence enhances this by adapting the document's behavior to meet specific compliance requirements, such as displaying relevant panels or workflows based on the user's role or jurisdiction.

Interoperability and Adaptability: The permanent global marker ensures seamless integration with external systems, while embedded intelligence enables the document to negotiate communication protocols and adapt its responses to different platforms. This combination ensures that the document can function effectively in diverse environments.

Predictive Security and Usability: Immutability protects the document from tampering, while embedded intelligence leverages machine learning to predict potential security risks and suggest preventive actions. This proactive approach enhances both security and usability, ensuring that the document serves the needs of its stakeholders effectively.

### Real-World Applications

The synergy of immutability and embedded intelligence has transformative implications across industries:

Legal and Compliance: Smart contracts can ensure the integrity of agreements while dynamically adapting to regulatory changes.

Finance: Immutable audit trails and intelligent analysis can enhance fraud detection and streamline reporting.

Healthcare: Patient records can remain secure and authentic while providing personalized access to authorized stakeholders.

Supply Chain: Immutable tracking and intelligent analysis can optimize logistics and ensure product authenticity.

In summary, the combination of immutability and embedded intelligence in smart documents creates a revolutionary framework for document management. By ensuring integrity, authenticity, and traceability while enabling dynamic interactions and personalized experiences, this synergy addresses longstanding challenges and unlocks new possibilities for innovation and efficiency.

### Alternative Terminology

The term “smart document” or “smart electronic document” can also be referred to as a self-determinative document, a self-tracking document, a self-assimilating document, a document with executable code, a document with embedded code, and/or in a variety of other ways depending on the context and on the features of the smart document. In some examples, a smart electronic document includes three elements, at minimum—data (e.g., content, audit trail, other metadata, etc.), executable code (e.g., an API), and a globally unique marker.

A smart document that performs hard copy control can be a technical solution to the persistent problem of managing and securing physical documents, which are often disconnected from their digital counterparts, prone to unauthorized modifications, and difficult to track or verify. This document structure may incorporate immutable content and an immutable audit trail, both immutably connected to an immutable global identifier, ensuring that the document's content, history, and identity remain tamper-proof, trustworthy, and verifiable. The machine-readable design of the smart document enables seamless integration with computational systems, enabling automated tracking, validation, and synchronization of physical and digital versions. Additionally, a smart document can embed intelligence in the form of executable code, which enables it to autonomously enforce hard copy control mechanisms, such as embedding unique identifiers in printed versions, issuing warnings about printing risks, and recording printing events in its audit trail. This embedded intelligence transforms the document into a responsive and interactive entity capable of managing its lifecycle across both physical and digital environments, providing a robust solution to the challenges of hard copy security, traceability, and operational inefficiencies.

A smart document with hard copy control may also address one or more of the problems of data security, inefficient use of device hardware, and inefficient use of network systems associated with traditional PDFs by leveraging its immutable structure, embedded intelligence, and machine-readable design. In terms of data security, a smart document may ensure that every printed copy is uniquely identifiable through embedded markers such as QR codes or invisible machine-readable identifiers, linking the hard copy back to its authoritative digital counterpart. This may prevent unauthorized duplication, enable real-time tracking, and ensure that physical documents remain secure and traceable. Regarding device hardware, traditional PDFs may require significant computational resources for rendering, extracting data, and managing versions, often leading to inefficiencies and hardware strain. A smart document may reduce these burdens by autonomously managing hard copy interactions, such as recording printing events, enforcing printing restrictions, and synchronizing annotations from physical documents back to their digital versions, reducing the need for redundant processing and optimizing hardware usage. Similarly, network systems that handle PDFs often experience bandwidth inefficiencies due to the transmission of large, static files and duplicate versions. A smart document may address this by maintaining a single source of truth that is universally accessible via its global identifier, enabling lightweight, API-driven interactions for hard copy management rather than transmitting entire files. This approach may reduce network bandwidth usage, streamline workflows, and ensure that both physical and digital documents are securely and efficiently managed across devices and systems, making hard copy control a critical feature of the smart document's infrastructure.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

Clause 1. A computer-implemented method, the computer-implemented method comprising: receiving, by an application executing on the computer, a request to convert a physical document to an electronic document provisioned as digital infrastructure, and converting responsive to the request, by the application executing on the computer, the physical document into the electronic document provisioned as digital infrastructure.

Clause 2. The computer-implemented method of clause 1, further comprises: interacting with the physical document via the application executing on the computer, and facilitating, via execution of the application, control of the electronic document provisioned as digital infrastructure responsive to the interaction with the physical document.

Clause 3. The computer-implemented method of clause 1 or 2, the physical document corresponds to a paper document, and the electronic document provisioned as digital infrastructure is stored in memory of the computer.

Clause 4. The computer-implemented method of any of clauses 1-3, wherein the receiving of the request to convert the physical document to the electronic document provisioned as digital infrastructure is responsive to scanning, using the application executing on the computer, the physical document.

Clause 5. The computer-implemented method of any of clauses 1-4, further comprises associating, automatically and without user intervention, a user of the computer on which the application is executing as a custodian of the physical document.

Clause 6. The computer-implemented method of any of clauses 1-5, further comprising: updating, via the execution of the electronic document, the electronic document to include the digital content that is modified and the additional digital content that is modified.

Clause 7. The computer-implemented method of any of clauses 1-6, wherein the interacting with the physical document via the application executing on the computer comprises including, by a user, a signature on the physical document, and scanning, using the application executing on the computer, the physical document that includes the signature.

Clause 8. The computer-implemented method of any of clauses 1-7, wherein the facilitating the control of the electronic document provisioned as digital infrastructure responsive to the interaction with the physical document comprises applying, automatically and without user intervention, the signature included in the physical document as part of the electronic document provisioned as digital infrastructure.

Clause 9. The computer-implemented method of any of clauses 1-8, further comprising scanning, using the application executing on the computer, an additional physical document in a real-world environment, and outputting, by the application, in an artificial reality environment generated by an artificial reality based device, data specific to the additional physical document in the real-world environment.

Clause 10. The computer-implemented method of any of clauses 1-9, wherein the additional data that is in the artificial reality environment overlays the additional physical document in the real-world environment.

Clause 11. The computer-implemented method of any of clauses 1-10, wherein the additional data is absent from the additional physical document in the real-world environment.

Clause 12. A system comprising: at least one physical processor, physical memory comprising computer-executable instructions that, when executed by the at least one physical processor, cause the at least one physical processor to receive, by an application executing on the at least one physical processor, a request to convert a physical document to an electronic document provisioned as digital infrastructure, and convert responsive to the request, by the application executing on the at least one physical processor, the physical document into the electronic document provisioned as digital infrastructure.

Clause 13. The system of clause 12, wherein the computer-executable instructions that, when executed by the at least one physical processor, further cause the at least one physical processor to: interact with the physical document via the application executing on the at least one physical processor, and facilitate, via execution of the application, control of the electronic document provisioned as digital infrastructure responsive to the interaction with the physical document.

Clause 14. The system of clause 12 or 13, wherein the physical document corresponds to a paper document, and the electronic document provisioned as digital infrastructure is stored in memory associated with the at least one physical processor.

Clause 15. The system of any of clauses 12-14, wherein the computer-executable instructions that, when executed by the at least one physical processor, cause the at least one physical processor to receive the request to convert the physical document to the electronic document provisioned as digital infrastructure responsive to scanning, using the application executing on the at least one physical processor, the physical document.

Clause 16. The system of any of clauses 12-15, wherein the computer-executable instructions that, when executed by the at least one physical processor, further cause the at least one physical processor to associate, automatically and without user intervention, a user of the at least one physical processor on which the application is executing as a custodian of the physical document.

Clause 17. The system of any of clauses 12-16, wherein the computer-executable instructions that, when executed by the at least one physical processor, further cause the at least one physical processor to: scan, using the application executing on a device that is different from the at least one physical processor, the physical document, and associating, automatically and without user intervention, an additional user of the device on which the application is executing as the custodian of the physical document.

Clause 18. A non-transitory computer-readable medium comprising one or more computer-executable instructions that, when executed by at least one processor of a computing device, cause the computing device to: receive, by an application executing on the computing device, a request to convert a physical document to an electronic document provisioned as digital infrastructure, and convert responsive to the request, by the application, the physical document into the electronic document provisioned as digital infrastructure.

Clause 19. The non-transitory computer-readable medium of clause 18, wherein the computer-executable instructions, when executed by at least one processor of a computing device, cause the computing device to: interact with the physical document via the application executing on the computing device, and facilitate, via execution of the application, control of the electronic document provisioned as digital infrastructure responsive to the interaction with the physical document.

Clause 20. The non-transitory computer-readable medium of clause 18 or 19, wherein the physical document corresponds to a paper document, and the electronic document provisioned as digital infrastructure is stored in memory of the computing device.

The features and clauses discussed herein may provide one or more of the advantages and/or solutions described, such as enhancing security, improving operational efficiency, or enabling dynamic access control. Additionally, these features and clauses may offer further or alternative benefits or address further or alternative challenges beyond those explicitly mentioned. The disclosed features and clauses are not limited to the specific advantages or solutions described and may be implemented in various ways to achieve additional or alternative benefits and/or solutions.

What is claimed is:

1. A computer-implemented method performed on a computer, the computer-implemented method comprising:
receiving, by an application executing on the computer, a request to convert a physical document to an electronic document provisioned as digital infrastructure; and
converting, responsive to the request and by the application executing on the computer, the physical document into the electronic document provisioned as digital infrastructure that comprises an application programming interface (API) that transforms the physical document into an entity that can interact with its environment.

2. The computer-implemented method of claim 1, further comprising:
interacting with the physical document via the application executing on the computer; and
facilitating, via execution of the application, control of the electronic document provisioned as digital infrastructure responsive to the interaction with the physical document.

3. The computer-implemented method of claim 1, wherein:
the physical document corresponds to a paper document; and
the electronic document provisioned as digital infrastructure is stored in memory of the computer.

4. The computer-implemented method of claim 1, wherein the receiving of the request to convert the physical document to the electronic document provisioned as digital infrastructure is responsive to scanning, using the application executing on the computer, the physical document.

5. The computer-implemented method of claim 4, further comprising:
associating, automatically and without user intervention, a user of the computer on which the application is executing as a custodian of the physical document.

6. The computer-implemented method of claim 5, further comprising:
scanning, using the application executing on a device that is different from the computer, the physical document; and
associating, automatically and without user intervention, an additional user of the device on which the application is executing as the custodian of the physical document.

7. The computer-implemented method of claim 1, further comprising interacting with the physical document via the application executing on the computer by:
including, by a user, a signature on the physical document; and
scanning, using the application executing on the computer, the physical document that includes the signature.

8. The computer-implemented method of claim 7, further comprising facilitating control of the electronic document provisioned as digital infrastructure responsive to the interaction with the physical document by:
applying, automatically and without user intervention, the signature included in the physical document as part of the electronic document provisioned as digital infrastructure.

9. The computer-implemented method of claim 1, further comprising:
scanning, using the application executing on the computer, an additional physical document in a real-world environment; and
outputting, by the application, in an artificial reality environment generated by an artificial reality based device, data specific to the additional physical document in the real-world environment.

10. The computer-implemented method of claim 9, wherein the additional data that is in the artificial reality environment overlays the additional physical document in the real-world environment.

11. The computer-implemented method of claim 10, wherein the additional data is absent from the additional physical document in the real-world environment.

12. The computer-implemented method of claim 1, wherein the electronic document comprises an immutable, unique identifier that links the physical document to the electronic document.

13. The computer-implemented method of claim 12, wherein the electronic document performs deduplication via the immutable, unique identifier.

14. The method of claim 1, wherein the electronic document is configured to interact with an artificial intelligence agent using a specialized protocol.

15. The method of claim 14, wherein the specialized protocol comprises a machine communication protocol.

16. The method of claim 1, wherein the electronic document comprises an artificial intelligence application programming interface configured to support artificial intelligence agents in at least one of querying, analyzing, or interacting with the electronic document in a structured manner.

17. The method of claim 1, wherein the electronic document enforces role-based access control on artificial intelligence agents.

18. The method of claim 1, wherein the electronic document is configured to manage artificial intelligence agent access to the electronic document by autonomously evaluating permissions for one or more specific portions of the electronic document.

19. The method of claim 1, wherein the electronic document is configured to maintain an audit trail for interactions between artificial intelligence agents and the electronic document by recording which agents accessed which portions of the electronic document and for what purpose.

20. The method of claim 1, wherein the electronic document is configured to host an in-document application that is configured for specific use by an artificial intelligence agent.

21. The method of claim 1, wherein the electronic document enables artificial intelligence analysis of engagement with the electronic document.

22. The method of claim 1, wherein the electronic document is configured to restrict access of an artificial intelligence agent to a sensitive portion of the electronic document.

23. The method of claim 1, wherein embedded intelligence of the electronic document is configured to provide one or more insights that inform artificial intelligence training.

24. The method of claim 1, wherein the electronic document is configured as a single source of truth in a manner that reduces artificial intelligence training bias caused by training on multiple copies of a traditional document.

25. A system comprising:
at least one physical processor;
physical memory comprising computer-executable instructions that, when executed by the at least one physical processor, cause the at least one physical processor to:
receive, by an application executing on the at least one physical processor, a request to convert a physical document to an electronic document provisioned as digital infrastructure; and
convert responsive to the request, by the application executing on the at least one physical processor, the physical document into the electronic document provisioned as digital infrastructure that comprises an application programming interface (API) that transforms the physical document into an entity that can interact with its environment.

26. The system of claim 25, wherein the computer-executable instructions that, when executed by the at least one physical processor, further cause the at least one physical processor to:
interact with the physical document via the application executing on the at least one physical processor; and
facilitate, via execution of the application, control of the electronic document provisioned as digital infrastructure responsive to the interaction with the physical document.

27. The system of claim 25, wherein:
the physical document corresponds to a paper document; and
the electronic document provisioned as digital infrastructure is stored in memory associated with the at least one physical processor.

28. The system of claim 25, wherein the computer-executable instructions that, when executed by the at least one physical processor, cause the at least one physical processor to receive the request to convert the physical document to the electronic document provisioned as digital infrastructure responsive to scanning, using the application executing on the at least one physical processor, the physical document.

29. The system of claim 25, wherein the computer-executable instructions that, when executed by the at least one physical processor, further cause the at least one physical processor to associate, automatically and without user intervention, a user of the at least one physical processor on which the application is executing as a custodian of the physical document.

30. The system of claim 29, wherein the computer-executable instructions that, when executed by the at least one physical processor, further cause the at least one physical processor to:
scan, using the application executing on a device that is different from the at least one physical processor, the physical document; and
associate, automatically and without user intervention, an additional user of the device on which the application is executing as the custodian of the physical document.

31. A non-transitory computer-readable medium comprising one or more computer-executable instructions that, when executed by at least one processor of a computing device, cause the computing device to:
receive, by an application executing on the computing device, a request to convert a physical document to an electronic document provisioned as digital infrastructure; and
convert responsive to the request, by the application, the physical document into the electronic document provisioned as digital infrastructure that comprises an application programming interface (API) that transforms the physical document into an entity that can interact with its environment.

32. The non-transitory computer-readable medium of claim 31, wherein the computer-executable instructions, when executed by at least one processor of a computing device, further cause the computing device to:
interact with the physical document via the application executing on the computing device; and
facilitate, via execution of the application, control of the electronic document provisioned as digital infrastructure responsive to the interaction with the physical document.

33. The non-transitory computer-readable medium of claim 32, wherein:
the physical document corresponds to a paper document; and
the electronic document provisioned as digital infrastructure is stored in memory of the computing device.
